(19) United States
(12) Patent Application Publication
(10) Pub. No.: US 2014/0152685 A1
(43) Pub. Date: Jun. 5, 2014

(54) SEMICONDUCTOR DEVICE AND PROGRAM

(71) Applicant: Semiconductor Energy Laboratory Co., Ltd., Atsugi-shi (JP)

(72) Inventor: Yuji IWAKI, Isehara (JP)

(73) Assignee: Semiconductor Energy Laboratory Co., Ltd., Atsugi-shi (JP)

(21) Appl. No.: 14/090,251

(22) Filed: Nov. 26, 2013

(30) Foreign Application Priority Data
Nov. 30, 2012 (JP) 2012-263310

(51) Int. Cl. G09G 5/37; G09G 5/373; G09G 5/02

(52) U.S. Cl. CPC G09G 5/37; G09G 5/02; G09G 5/373
USPC 345/589; 345/660

(57) ABSTRACT

A semiconductor device having an eye-friendly display function is provided. When a display portion displays text, a difference between a gray level of the text and a gray level of a background of the text is reduced depending on a scrolling speed of a screen of the display portion. In other words, during fast scrolling, text visibility is lowered by bringing the gray level of the text closer to the gray level of the background. This can prevent a user from following the text with eyes at the time of fast scrolling, thereby eliminating unnecessary movement of eye muscles and reducing stimuli to the optic nerve. In this manner, eye strain can be reduced.

### BACKGROUND OF THE INVENTION

1. Field of the Invention

The present invention relates to an object, a method, a manufacturing method, a process, a machine, a manufacture, or a composition of matter. The present invention particularly relates to a semiconductor device, a driving method thereof, a manufacturing method thereof, a program for operating the semiconductor device, or the like.

Note that in this specification, a semiconductor device means a circuit including a semiconductor element (e.g., a transistor or a diode) and a device including the circuit. The semiconductor device also means any device that can function by utilizing semiconductor characteristics. For example, an integrated circuit, a chip including an integrated circuit, a display device, a light-emitting device, a lighting device, and an electronic device are all semiconductor devices.

2. Description of the Related Art

With the development of information technology (IT), IT devices such as personal computers, cellular phones, and smartphones are used daily not only at work but also at home. At the same time, an eye health problem caused by continuous use of these devices has surfaced, and a device for reducing eye strain has been proposed (Patent Document 1).

Causes of eye strain due to use of personal computers and the like include intense light from screens, fast movement of text by scrolling, and the like. A portable electronic device, such as a cellular phone, with increased speed of response to text scrolling to reduce flickers has been proposed (Patent Document 2).

### REFERENCES

[Patent Document 1] Japanese Published Patent Application No. 2003-047636
[Patent Document 2] Japanese Published Patent Application No. 2009-009553

### SUMMARY OF THE INVENTION

An object of one embodiment of the present invention is to provide a semiconductor device having a function of performing display with less eye strain. Another object of one embodiment of the present invention is to provide a semiconductor device having a function of performing eye-friendly display.

Another object of one embodiment of the present invention is to provide a semiconductor device which consumes less power. Another object of one embodiment of the present invention is to provide a semiconductor device including a pixel with a high aperture ratio. Another object of one embodiment of the present invention is to provide a semiconductor device whose display function is less affected by pressing on a screen with a finger or the like. Another object of one embodiment of the present invention is to provide a semiconductor device which is less affected by screen flicker. Another object of one embodiment of the present invention is to provide a semiconductor device capable of displaying a high-resolution image. Another object of one embodiment of the present invention is to provide a semiconductor device with low drive voltage. Another object of one embodiment of the present invention is to provide a semiconductor device with low off-state current. Another object of one embodiment of the present invention is to provide a bendable semiconductor device.

Note that the descriptions of these objects do not disturb the existence of any other object. Note that in one embodiment of the present invention, there is no need to achieve all the objects. Objects other than the above-described objects will be apparent from and can be derived from the description of the specification, drawings, claims, and the like.

One embodiment of the present invention is a semiconductor device including a display unit, in which when the display unit displays text, a process of reducing a difference between a gray level of the text and a gray level of a background of the text is performed depending on a scrolling speed of a screen of the display unit.

One embodiment of the present invention is a program for controlling a display unit which includes: a first step of determining whether to display text on a screen of the display unit; a second step of determining a scrolling speed of the screen of the display unit; and a third step of reducing a difference between a gray level of the text displayed by the display unit and a gray level of a background of the text depending on the scrolling speed.

In one embodiment of the present invention, a semiconductor device having a function of performing eye-friendly display with less eye strain can be provided.

### BRIEF DESCRIPTION OF THE DRAWINGS

FIG. 1 is a flowchart of an example of a text displaying process.

FIG. 2 is a flowchart of an example of a text displaying process.

FIG. 3 is a block diagram illustrating an example of a configuration of an information processing terminal.

FIG. 4A is a block diagram illustrating an example of a configuration of a display portion, FIG. 4B is a plan-view diagram illustrating a structure example of a display module, and FIGS. 4C and 4D are circuit diagrams each illustrating an example of a configuration of a pixel.

FIG. 5A is a plan-view diagram illustrating an example of a structure of a pixel, and FIG. 5B is a cross-sectional diagram illustrating a structure example of a display module.

FIG. 6 is a cross-sectional diagram illustrating a structure example of a display module.

FIG. 7 shows emission spectra of backlights.

FIGS. 8A and 8B are schematic diagrams each illustrating an example of a method for updating a screen.

FIG. 9 is a timing chart illustrating an example of a method for updating a screen.

FIG. 10 is a schematic diagram illustrating an example of a method for switching a screen.

FIGS. 11A and 11B are a plan-view diagram and a cross-sectional diagram illustrating a structure example of a transistor.

FIGS. 12A to 12D are cross-sectional diagrams illustrating an example of a method for manufacturing a transistor.

FIGS. 13A and 13B are cross-sectional diagrams each illustrating a structure example of a transistor.

FIGS. 14A to 14C are cross-sectional diagrams each illustrating a structure example of a transistor.

FIG. 15A is a perspective diagram illustrating a structure example of a touch panel, and FIG. 15B is an exploded perspective diagram of FIG. 15A.

FIG. 16 is a cross-sectional diagram of FIG. 15A.

FIGS. 17A and 17B are circuit diagrams illustrating an example of a configuration of a touch sensor.

FIG. 18 is a timing chart illustrating an example of operation of a touch panel.

FIGS. 19A and 19B are circuit diagrams illustrating an example of operation of a touch panel.

FIGS. 20A to 20C are cross-sectional diagrams illustrating structure examples of pixels in touch panels for an FFS mode, an IPS mode, and a VA mode, respectively.

FIGS. 21A to 21F are external-view diagrams each illustrating a structure example of a semiconductor device.

### DETAILED DESCRIPTION OF THE INVENTION

Embodiments of the present invention will be described in detail below with reference to drawings. Note that the present invention is not limited to the following description, and it is easily understood by those skilled in the art that various changes and modifications can be made without departing from the spirit and scope of the present invention. Therefore, the present invention should not be construed as being limited to the description in the following embodiments.

In the drawings used for the description of embodiments of the present invention, the same portions or portions having a similar function are denoted by the same reference numerals, and the repeated description thereof is omitted.

### Embodiment 1

Reading text on a screen of a personal computer or the like causes more eye strain than reading printed text on paper does because it requires a completely different way of using eyes. A display device requires scrolling to move displayed text on a screen, and therefore, text is moved rapidly. However, a user stares at a screen unconsciously in an attempt to read fast-moving text, and this causes eye strain.

In view of this explanation, a semiconductor device including a display portion capable of displaying text with less eye strain is described in this embodiment.

Methods for quantifying eye fatigue have been studied. For example, critical flicker (fusion) frequency (CFF) is known as an indicator for evaluating nervous fatigue. Further, accommodation time, accommodation near point, and the like are known as indicators for evaluating muscular fatigue.

Others methods for evaluating eye fatigue include electroencephalography, thermography, counting the number of times of blinking, measuring the amount of tears, measuring the speed of contractile response of the pupil, and questionnaires for surveying subjective symptoms.

Thus, performance of eye-friendly display can be evaluated by a variety of methods such as those described above.

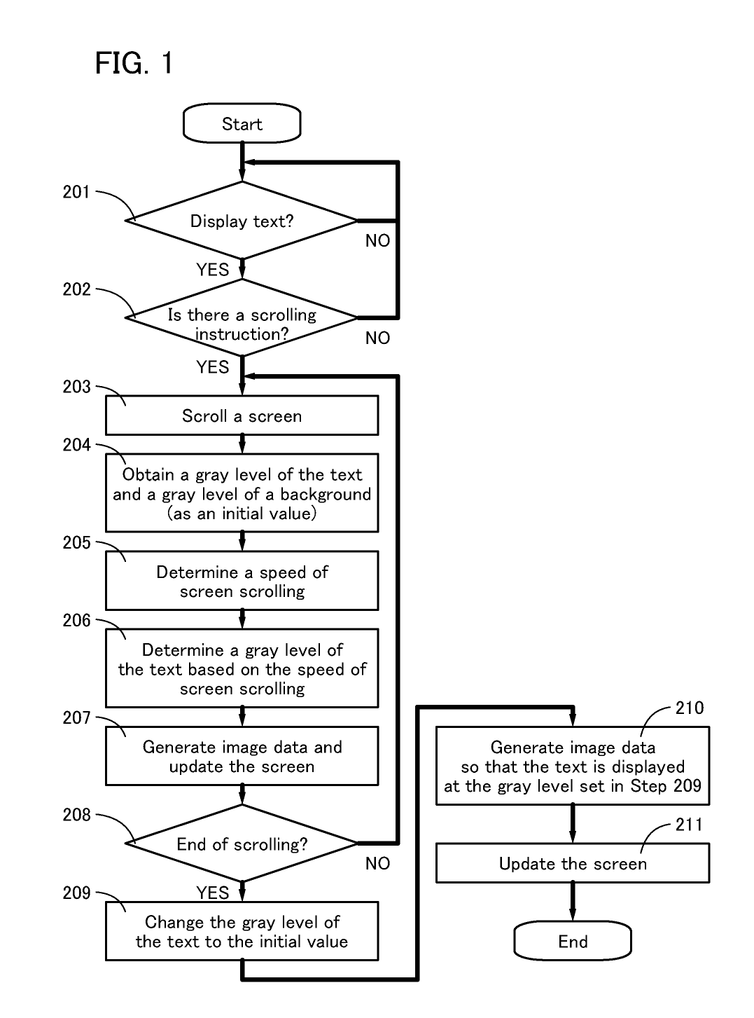

In this embodiment, a display device and an information processing system including a display unit are described as examples of semiconductor devices. This embodiment is described below with reference to FIGS. 1 to 3, FIGS. 4A to 4D, FIGS. 5A and 5B, and FIG. 6.

### <1.1. Information Processing System>

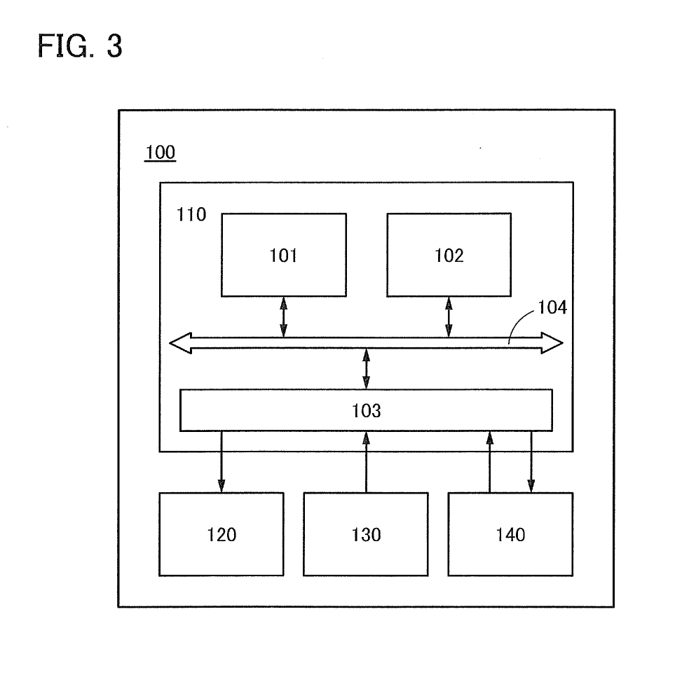

FIG. 3 is a block diagram illustrating an example of a configuration of a display device of this embodiment. As illustrated in FIG. 3, an information processing system 100 includes an arithmetic portion 110, a display unit 120, an input unit 130, and a memory device 140.

The arithmetic portion 110 includes an arithmetic device 101, a memory device 102, an input/output interface 103 (hereinafter referred to as “I/O 103”), and a transmission path 104. The arithmetic portion 110 has a function of controlling the whole information processing system 100 by executing instructions.

The transmission path 104 connects the arithmetic device 101, the memory device 102, and the I/O 103. The arithmetic portion 110 can exchange data with the display unit 120, the input unit 130, and the memory device 140 through the I/O 103. For example, an input signal from the input unit 130 is input to the I/O 103, and is transmitted to the arithmetic device 101 through the transmission path 104.

The memory device 102 stores data necessary for processing by the arithmetic device 101 or data input through the I/O 103.

The arithmetic device 101 executes a program to operate the information processing system 100. For example, the arithmetic device 101 performs processes for analyzing an input signal from the input unit 130, reading data from the memory device 140, writing data to the memory device 140, generating a signal to be output to the display unit 120, and the like.

The display unit 120 includes at least a display portion for displaying an image. Images are displayed by the display portion in accordance with signals input from the arithmetic portion 110. The screen of the display portion includes a pixel portion including a plurality of pixels. The pixel density of the display portion is preferably higher than or equal to 150 pixels per inch (ppi), more preferably higher than or equal to 200 ppi.

The input unit 130 has a function of inputting data to the arithmetic portion 110. As the input unit 130, various human interfaces can be used, and one or more input devices are provided. For example, a keyboard, a mouse, a pointing device, a touch panel, a sensor for sensing gestures, eye movements, or the like, a microphone, or the like can be used as the input unit 130.

The memory device 140 stores various kinds of data such as a program and an image signal. A memory device having larger memory capacity than that of the memory device 102 is preferably used. The memory device 140 may be provided as needed.

Note that the information processing system 100 is not limited to a semiconductor device in which the arithmetic portion 110 is integrated with the display unit 120, the input unit 130, and the memory device 140 as in a cellular phone. For example, as the display unit 120, a display device such as a monitor can be used. For example, as the memory device 140, an external hard disk, a USB memory, or the like can be used. The arithmetic portion 110 is connected to the display unit 120, the input unit 130, and the memory device 140 either with or without wires.

### <1.2.1. Method 1 for Displaying Text>

Next, a process performed by the arithmetic portion 110 for displaying text is described.

FIG. 1 is a flowchart illustrating an example of the process performed by the arithmetic portion 110 for displaying text. In the process in FIG. 1, text visibility can be lowered by reducing a difference between the gray level of text and the gray level of a background depending on the speed of scrolling. This can prevent a user from following text with eyes at the time of fast scrolling, thereby eliminating unnecessary movement of eye muscles and reducing stimuli to the optic nerve. In this manner, eye strain can be reduced. The flowchart in FIG. 1 is described below.

First, in Step 201, the arithmetic portion 110 determines whether or not the display unit 120 displays text.

In the case of displaying the text, in Step 202, the arithmetic portion 110 determines whether or not there is a scrolling instruction to scroll a screen of the display unit 120. Whether there is a scrolling instruction or not is determined from mouse or keyboard operation or the like or from a program executed by the arithmetic portion 110.

In the case where there is a scrolling instruction, Steps 203 to 208 are performed to change a difference between the gray level of the text and the gray level of a background depending on the speed of scrolling.

First, the arithmetic portion 110 executes the scrolling instruction to cause screen scrolling (Step 203). Next, image data is analyzed to obtain the gray level of the text (a font) and the gray level of the background (Step 204). The gray level of the text is changed using the value obtained in Step 204 as an initial value.

In Step 205, the arithmetic portion 110 determines the speed of screen scrolling. The speed of scrolling is determined from a signal from the input unit 130 such as a mouse, an instruction of a running application, or the like.

In Step 206, the arithmetic portion 110 determines the gray level of the text based on the speed determined in Step 205. In the case where the speed of scrolling is high, the gray level of the text is brought close to the gray level of the background so as to lower text visibility. In the case where the speed of scrolling is low, the gray level of the text is not changed or is brought closer to the initial value of the gray level obtained in Step 204.

In Step 207, image data is generated so that the text is displayed at the determined gray level. Then, a control signal, together with the generated image data, is output to the display unit 120 to update a screen. The display unit 120 displays an image based on the image data under the control of the arithmetic portion 110.

In Step 208, the arithmetic portion 110 determines whether or not the scrolling has ended. This is determined from an input signal from the input unit 130 or an instruction of a running application, as in Step 202. In the case where the scrolling has not ended, Steps 203 to 208 are performed again. In other words, while the screen is being scrolled, the gray level of the text can be changed depending on the speed of scrolling. Accordingly, by repeating Steps 203 to 208, the gray level of the text can be gradually brought closer to the gray level of the background as the speed of scrolling increases, and the gray level of the text can be gradually brought back to the initial value as the speed of scrolling decreases.

For example, in one method for changing the gray level of the text, while the speed of scrolling is higher than a preset threshold value, the gray level of the text is changed so as to be gradually brought closer to the gray level of the background and eventually become the same as the gray level of the background. In the case where an instruction to decrease the speed of scrolling is executed or in the case where the speed is lower than the preset threshold value, the gray level of the text is changed so as to be gradually brought closer to the initial value and eventually become the same as the initial value.

Note that the gray level of the text, or the difference between the gray level of the text and the gray level of the background, with respect to the speed of scrolling may be optionally set by a user.

Such control allows a user to continue work because the gray level of text is not changed while a screen is being scrolled at a speed where the text can be read without eye strain. On the other hand, while the screen is being scrolled at a speed higher than a speed where the text can be followed with eyes, the text can blend into the background by gradually bringing the gray level of the text closer to the gray level of the background. When the visibility of text is lowered in the above manner without causing a user to feel uncomfortable, the eyes can be prevented from moving to follow screen scrolling.

In the case where a determination that the scrolling has ended is made in Step 208, Steps 209 to 211 are performed so that the display unit 120 displays the text at the initial value of the gray level. In Step 209, the gray level of the text is changed to the initial value. In Step 210, image data is generated so that the text is displayed at the gray level set in Step 209. In Step 211, a control signal, together with the image data, is output to the display unit 120 to update the screen of the display unit 120.

Note that in the case where the gray level of the text is greatly different from the initial value in Step 209, it is preferable to repeat Steps 210 and 211 so that the gray level of the text is gradually brought back to the initial value. This can reduce a change in contrast at the time of updating the screen and accordingly reduce eye strain.

### <1.2.2. Method 2 for Displaying Text>

Another process performed by the arithmetic portion 110 for displaying text is described.

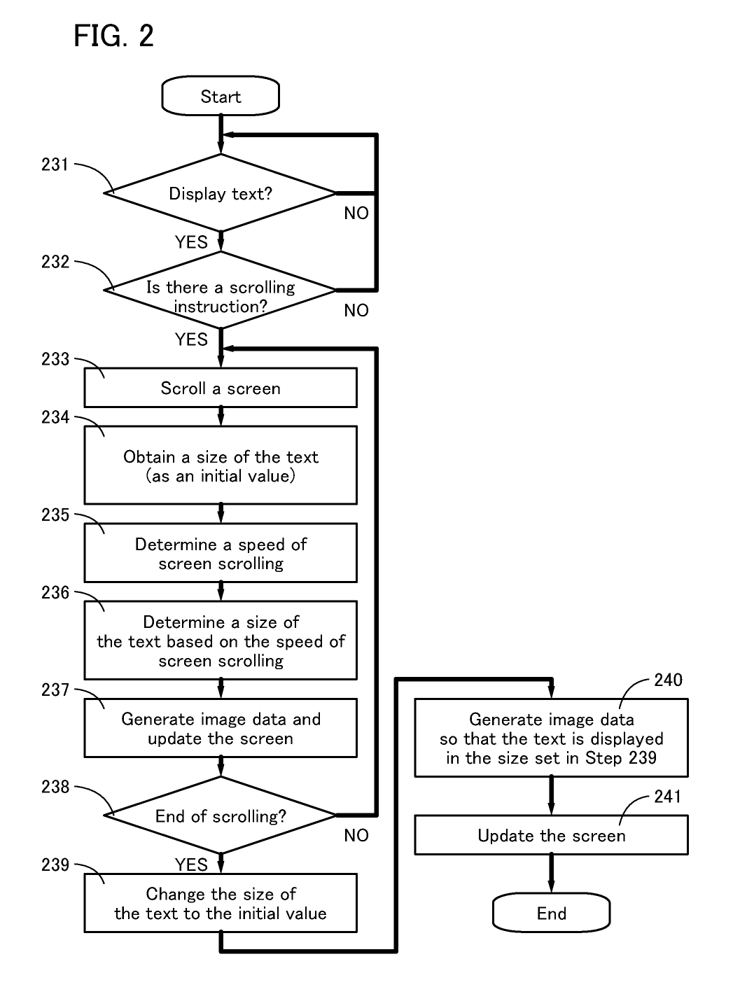

FIG. 2 is a flowchart illustrating an example of the process performed by the arithmetic portion 110 for displaying text. In the process in FIG. 2, text visibility is lowered by decreasing the size of text depending on the speed of scrolling. That is, text is made difficult to see at the time of fast scrolling to prevent a user from following the text with the eyes. Accordingly, tension in eye muscles and stimuli to the optic nerve are reduced, and in this mariner, eye strain can be reduced. The flowchart in FIG. 2 is described below. The description of steps similar to those in FIG. 1 is omitted here.

First, Steps 231 and 232 are performed in a manner similar to Steps 201 and 202. Then, in the case where it is determined that there is a scrolling instruction, scrolling is performed in Step 233, and the size of text (a font) is obtained in Step 234. The size of the text is changed using the obtained value as an initial value in a subsequent step. In Step 235, the arithmetic portion 110 determines the speed of scrolling as in Step 205.

In Step 236, the arithmetic portion 110 determines the size of the text based on the speed determined in Step 235. In the case where the speed of scrolling is high, the size of the text is decreased so as to lower text visibility. In the case where the speed of scrolling is low, the size of the text is not changed or is brought closer to the initial value obtained in Step 234.

In Step 237, the arithmetic portion 110 generates image data so that the text is displayed in the determined size. In addition, the image data, together with a control signal for updating the screen, is output to the display unit 120. The display unit 120 displays an image based on the image data under the control of the arithmetic portion 110 to update the screen.

Step 238 is similar to Step 208, in which the arithmetic portion 110 determines whether or not the scrolling has ended. In the case where the scrolling has not ended, Steps 233 to 238 are performed again. In other words, while the screen is being scrolled, the size of the text can be changed depending on the speed of scrolling. Accordingly, by repeating Steps 233 to 238, the size of the text can be gradually decreased as the speed of scrolling increases, and the size of the text can be gradually brought back to the initial value as the speed of scrolling decreases.

For example, in one method for changing the size of the text, while the speed of scrolling is higher than a preset threshold value, the size of the text is changed so as to gradually decrease. Eventually, only the background may be displayed with no text displayed. In the case where an instruction to decrease the speed of scrolling is executed or in the case where the speed of scrolling is lower than the preset threshold value, the size of the text is changed so as to gradually get closer to the initial value and eventually become the same as the initial value.

Note that the size of the text, the rate of size change, or the like with respect to the speed of scrolling can be set by a user.

By such control, the size of the text is not changed while a screen is being scrolled at a speed where the text is visible without eye strain. The size of the text is decreased while the screen is being scrolled at a speed higher than a speed where the text can be followed with eyes; accordingly, the text can blend into a background. In other words, during fast scrolling, the visibility of text can be lowered without causing a user to feel uncomfortable.

In the case where a determination that the scrolling has ended is made in Step 238, Steps 239 to 241 are performed so that the display unit 120 displays the text at the initial value of the size. In Step 239, the size of the text is changed to the initial value. Then, in Step 240, an image signal is generated so that the text is displayed in the size set in Step 239. In Step 241, a control signal, together with the image signal, is output to the display unit 120 to update the screen of the display unit 120.

Note that in the case where the size of the text is greatly different from the initial value in Step 239, it is preferable to repeat Steps 240 and 241 so that the size of the text is gradually brought back to the initial value. This can reduce a change of the screen at the time of updating the screen and accordingly reduce eye strain.

### <1.2.3. Method 3 for Displaying Text>

The process in FIG. 1 can be combined with the process in FIG. 2. That is, both the gray level and the size of the text can be changed depending on the speed of scrolling.

Although the processes of adjusting the gray level and the size of the text depending on the scrolling speed (the scrolling instruction) are described with reference to FIGS. 1 and 2, the gray level and the size of the text can be adjusted depending on an alternative to the scrolling instruction in the information processing system 100. For example, the gray level and/or the size of the text may be adjusted depending on an input from the input unit 130 (e.g., the frequency of text inputting, or the result of detecting user's eye movement), an application run by the arithmetic portion 110, or the like.

In some cases, it is possible not to adjust the gray level and the size of the text depending on user's setting, use environment, an application run by the arithmetic portion 110, or the like.

### <1.3. Example of Configuration of Display Unit>

Next, the display unit 120 is described. As the display unit 120, any of a variety of display units such as a liquid crystal display device, an organic EL display device, and electronic paper can be used. The semiconductor device in this embodiment includes, in its category, the display unit 120 (display device) which is an electronic device separate from the arithmetic portion 110, as long as the gray level and the size of text can be controlled as described above with a control signal from the external arithmetic portion 110 or the like.

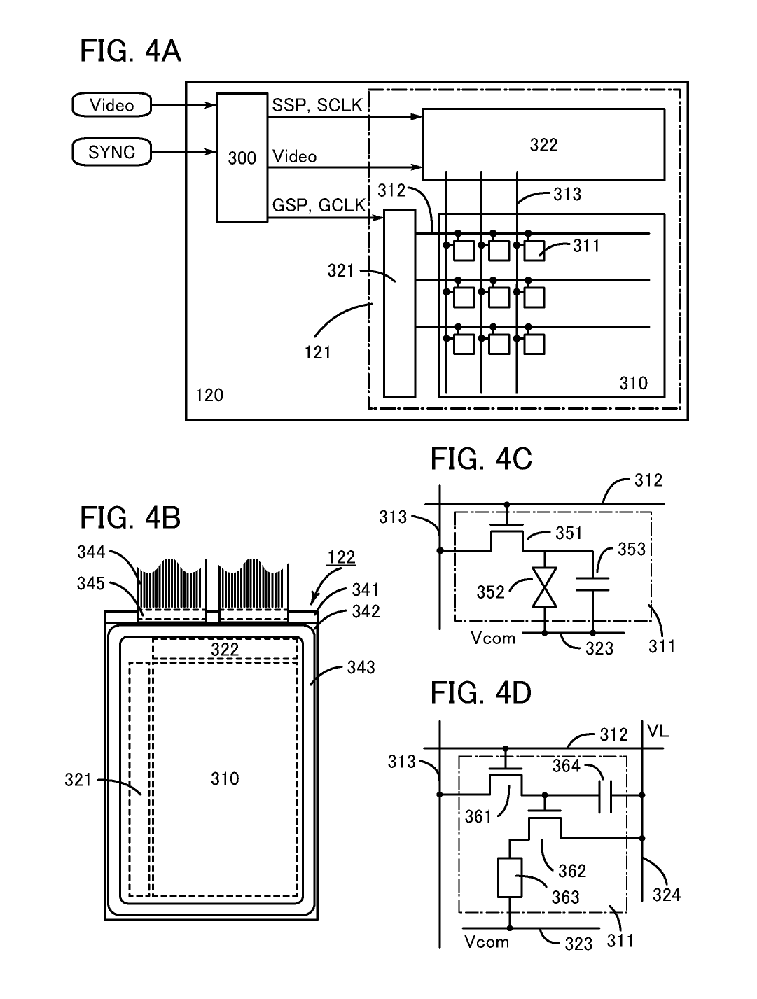

FIG. 4A is a block diagram illustrating an example of a configuration of the display unit 120. As illustrated in FIG. 4A, the display unit 120 includes a control circuit 300, a pixel portion 310, a scan line driver circuit 321, and a data line driver circuit 322.

The pixel portion 310 includes an array of a plurality of pixels 311. The pixels 311 in the same row are connected to the scan line driver circuit 321 through a common scan line 312, and the pixels 311 in the same column are connected to the data line driver circuit 322 through a common data line 313.

The scan line driver circuit 321 outputs, to the scan line 312, a scan signal for selecting the pixel 311 into which a data signal is to be written. The data line driver circuit 322 processes an input image signal to generate a data signal, and outputs the data signal to the data line 313.

The control circuit 300 controls the whole display unit 120. An image signal (Video), a synchronization signal (SYNC) for controlling updating of the screen, and the like are input to the control circuit 300. Examples of the synchronization signal include a horizontal synchronization signal (Hsync), a vertical synchronization signal (Vsync), and a reference clock signal (CLK).

The pixel 311 includes a switching element whose connection to the data line 313 is controlled by a scan signal. When the switching element is turned on, a data signal is written into the pixel 311 through the data line 313.

A circuit block 121 in FIG. 4A can be provided as a display module. FIG. 4B is a plan-view diagram illustrating an example of a modular structure of the circuit block 121. A display module 122 includes the circuits of the circuit block 121. The display module 122 also includes a substrate 341 and a substrate 342 which are provided so as to face each other. The substrate 341 and the substrate 342 are fixed using a sealing member 343 formed therearound, so as to face each other with a space provided therebetween. The circuits (310, 321, and 322) of the circuit block 121 are formed over the substrate 341. In addition, a flexible printed circuit (FPC) 344 is provided for input of potentials and signals to the circuits (310, 321, and 322). The FPC 344 is attached to the substrate 341 with an anisotropic conductive film 345.

Note that an IC chip including the control circuit 300 may be mounted on the display module 122. Furthermore, an IC chip including part or the whole of the scan line driver circuit 321 and the data line driver circuit 322 may be mounted on the substrate 341. Examples of mounting methods include a chip on glass (COG) method, a wire bonding method, a tape automated bonding (TAB) method, and the like.

As a display element which can be used in the pixel 311, any of a variety of display elements such as a light-emitting element like an EL element, a liquid crystal element, and a display element performing display by an electrophoretic method or an electronic liquid powder method can be used.

FIGS. 4C and 4D each illustrate an example of a configuration of the pixel 311. FIG. 4C is a circuit diagram of the pixel 311 including a liquid crystal element as a display element, and FIG. 4D is a circuit diagram of the pixel 311 including an EL element as a display element.

As illustrated in FIG. 4C, the pixel 311 includes a transistor 351, a liquid crystal element 352, and a capacitor 353.

The liquid crystal element 352 includes two electrodes and a liquid crystal layer between the two electrodes. The liquid crystal layer is provided between the substrate 341 and the substrate 342 in the step of enclosing a liquid crystal material.

The capacitor 353 has a function of holding a potential between the two electrodes of the liquid crystal element 352. One electrode of the liquid crystal element 352 and one electrode of the capacitor 353 are connected to a wiring 323. A constant potential (Vcom) is input to the wiring 323, and the potentials of the one electrode of the liquid crystal element 352 and the one electrode of the capacitor 353 are fixed to Vcom.

Note that when a display element which performs display by an electronic liquid powder method or the like is provided in place of the liquid crystal element 352 in FIG. 4C, the display unit 120 can function as electronic paper. In that case, the capacitor 353 is not necessarily provided.

In FIG. 4D, the pixel 311 includes a transistor 361, a transistor 362, an EL element 363, and a capacitor 364.

The EL element 363 includes two electrodes (an anode and a cathode) and a light-emitting layer between the two electrodes. The EL element 363 is capable of changing emission intensity with a current or a voltage between the two electrodes. The light-emitting layer includes at least a light-emitting substance. Examples of the light-emitting substance include organic EL materials, inorganic EL materials, and the like. Light emission from the light-emitting layer includes light emission (fluorescence) which is generated in returning from a singlet excited state to a ground state and light emission (phosphorescence) which is generated in returning from a triplet excited state to a ground state.

One electrode of the EL element 363 is connected to the wiring 323 to which a constant potential (Vcom) is input. The transistor 362 and the capacitor 364 are connected to a wiring 324 to which a constant potential (VL) is input. The emission intensity of the EL element 363 is controlled with the value of a current flowing through the transistor 362.

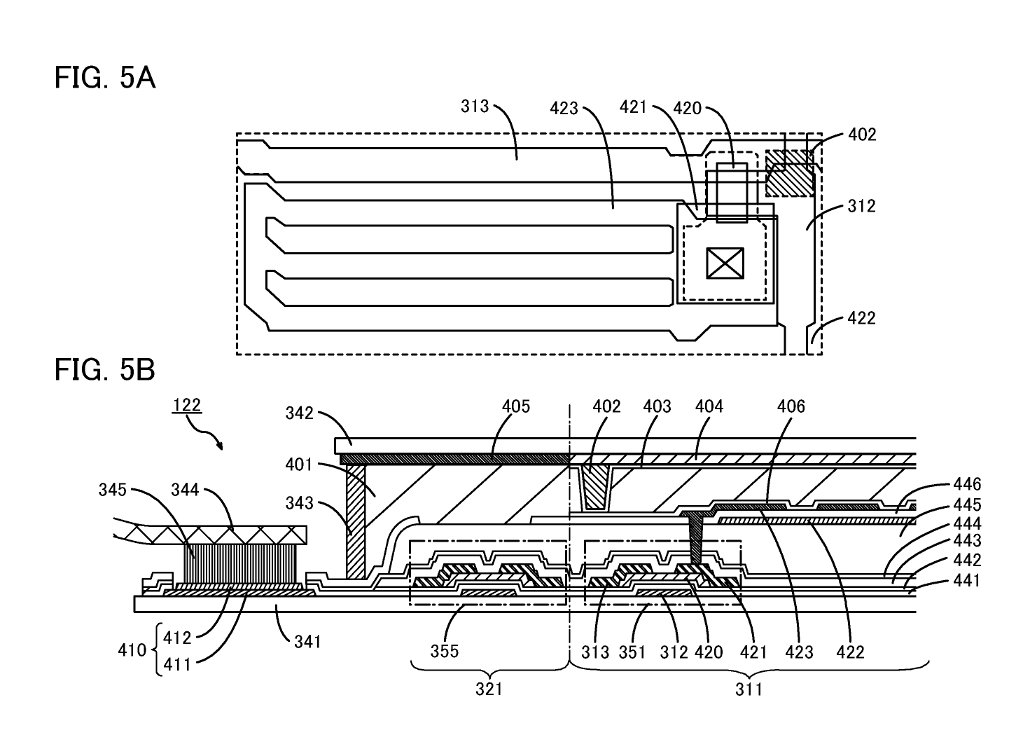

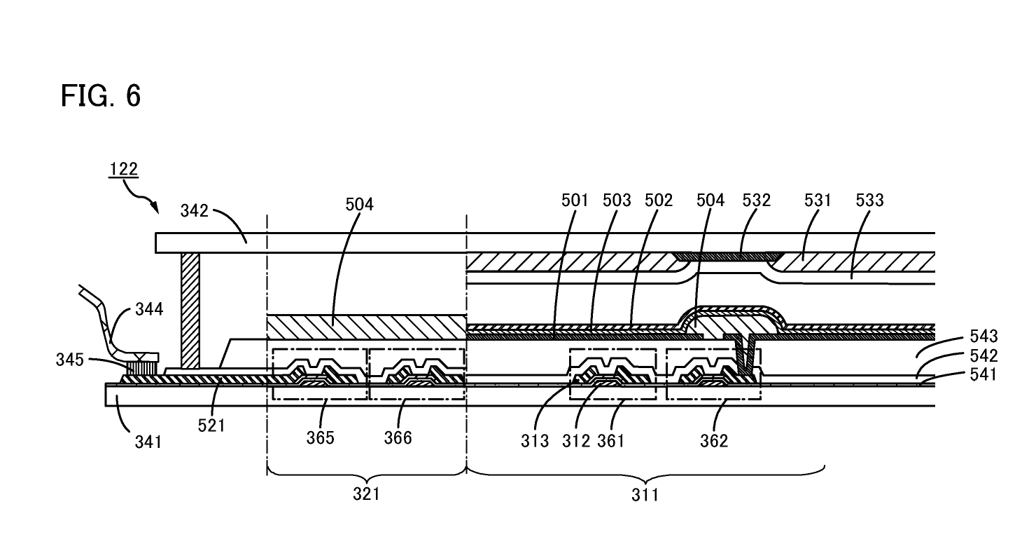

More specific structures of the display module 122 are described with reference to FIGS. 5A and 5B and FIG. 6.

<1.3.a. Liquid Crystal Module>

First, a display module of an active-matrix liquid crystal display device (hereafter referred to as “liquid crystal module”) is described. FIG. 5A is a plan-view diagram illustrating an example of a specific structure of the pixel 311 in FIG. 4C. FIG. 5B is a cross-sectional diagram illustrating a structure example of the display module 122 (liquid crystal module) including the pixel 311 in FIG. 5A. The pixel in FIG. 5A is used for a fringe field switching (FFS) mode. The cross-sectional diagram of FIG. 5B shows not a cross section taken along a particular section line in the display module 122 but a cross section illustrating a stacked structure of the display module 122. FIG. 5B shows a transistor 355 formed in the scan line driver circuit 321 as a typical example of elements in the scan line driver circuit 321 and the data line driver circuit 322.

There is a liquid crystal layer 401 enclosed by the sealing member 343 between the substrate 341 and the substrate 342. The cell gap of the display module 122 is maintained by a spacer 402 formed over the substrate 342. As illustrated in FIG. 5A, the spacer 402 is located in a region where the scan line 312 and the data line 313 overlap with each other over the substrate 341. Such a region does not contribute to display because it is a region where the alignment of the liquid crystal material is disordered. When the spacer 402 is formed in such a region, the aperture ratio of the pixel 311 can be increased to 50% or more. Note that the spacer 402 may be provided on the substrate 341 side.

The substrate 342 is further provided with an alignment film 403, a color filter 404, and a black matrix 405. The color filter 404 is provided in a region overlapping with a pixel electrode 423. The black matrix 405 is formed using an organic resin film and is provided to cover a region which does not contribute to display and in which the scan line 312, the data line 313, the scan line driver circuit 321, the data line driver circuit 322, and the like are formed.

Over the substrate 341, a terminal portion 410 for connection to the FPC 344 is formed outside the sealing member 343. The terminal portion 410 includes an electrode 411 and an electrode 412. The electrode 411 is formed using the same conductive film as gate electrodes of the transistors 351 and 355. The electrode 412 is formed using the same transparent conductive film as a common electrode 422 in the pixel 311. The FPC 344 and the electrode 412 are connected by the anisotropic conductive film 345.

The transistor 351 includes the scan line 312, the data line 313, and a semiconductor layer 420. The semiconductor layer 420 includes at least one semiconductor layer which includes a channel formation region. Insulating layers 441 and 442 constitute a gate insulating layer in the scan line driver circuit 321. The transistor 355 has the same stacked structure as the transistor 351. Insulating layers 443 to 445 are formed so as to cover the transistors 351 and 355. The insulating layer 445 serves as a planarization film. As the insulating layer 445, an organic resin film of an acrylic resin, polyimide, a benzocyclobutene-based resin, a siloxane-based resin, polyamide, an epoxy resin, or the like can be formed.

The common electrode 422 is formed over the insulating layer 445. The pixel electrode 423 is formed over the common electrode 422 with an insulating layer 446 provided therebetween. An alignment film 406 is formed so as to cover the pixel electrode 423.

The pixel electrode 423 includes a plurality of stripe-shaped regions. Here, as illustrated in FIG. 5A, a plurality of slits is formed in the pixel electrode 423. Such a shape enables a fringe electric field including a component parallel to the substrate 341 to be generated between the common electrode 422 and the pixel electrode 423.

The common electrode 422 is common to all the pixels 311 and has an opening in a region overlapping with an electrode 421. In the insulating layers 443 to 446, a contact hole is formed in a region overlapping with the opening in the common electrode 422. The pixel electrode 423 is in contact with the electrode 421 through the contact hole.

A region where the common electrode 422 and the pixel electrode 423 overlap with each other serves as the capacitor 353 with the insulating layer 446 used as a dielectric. In other words, in the pixel 311 for the FFS mode, a capacitor can be added in parallel to the liquid crystal element 352 without formation of an auxiliary capacitor line which decreases the aperture ratio. As a result, the aperture ratio can be 50% or more, or 60% or more.

Although the pixel for the FFS mode is illustrated as an example in FIGS. 5A and 5B, the pixel 311 may have a structure for another horizontal electric field mode such as an IPS mode. Alternatively, a pixel structure for a vertical electric field mode in which a common electrode is provided on the substrate 342 side may be used. When the screen is touched by a finger or the like, an electric field is less disordered in a horizontal electric field mode than in a vertical electric field mode; thus, a horizontal electric field mode liquid crystal display module is more suitable as a display module for a touch panel.

An FFS mode liquid crystal display device can have a wider viewing angle and higher contrast than an IPS mode liquid crystal display device and can be driven at lower voltage than the IPS mode one; thus, it is extremely suitable as a high-definition display device for a portable electronic device when a transistor including an oxide semiconductor is used.

<1.3.b. EL Module>

A display module of an active-matrix EL display device (hereafter referred to as “EL module”) is described with reference to FIG. 6. FIG. 6 is a cross-sectional diagram illustrating a structure example of the display module 122 (EL module) including the pixel 311 in FIG. 4D. The cross-sectional diagram of FIG. 6 shows not a cross section taken along a particular section line in the display module 122 but a cross section illustrating a stacked structure of the display module 122.

There is no particular limitation on a color display method for the EL module, and any of a separate coloring method, a color filter method, and a color conversion method can be used. FIG. 6 illustrates the pixel 311 for a color filter method. FIG. 6 shows a transistor 365 and a transistor 366 formed in the scan line driver circuit 321 as an example of elements in the scan line driver circuit 321 and the data line driver circuit 322. The transistors 361 and 362 in the pixel 311 and transistors in the scan line driver circuit 321 and the data line driver circuit 322 have similar stacked structures.

As illustrated in FIG. 6, a wiring 521 formed over the substrate 341 is connected to the FPC 344 through the anisotropic conductive film 345. The wiring 521 serves as a lead wiring in FIG. 6.

Insulating layers 541 to 543 each having a single-layer or stacked structure are formed over the substrate 341. The insulating layer 541 serves as an insulating layer in the transistors 361, 362, 365, and 366. An electrode 501, an electrode 502, and an EL layer 503 are formed over the insulating layer 543. A stacked portion of the electrode 501, the electrode 502, and the EL layer 503 functions as the EL element 363. The EL layer 503 includes at least a light-emitting layer. Note that the EL element 363 in FIG. 6 has a bottom-emission structure, and the electrode 501 is formed using a conductive film which transmits visible light.

A partition 504 is formed so as to cover an end portion of the electrode 501. As the EL layer 503, layers (such as light-emitting layers) including different materials are formed separately for EL elements 363 which emit light of different colors.

The substrate 342 is provided with a color filter 531 as a coloring layer in a region overlapping with the EL element 363 (a light-emitting region thereof), and is also provided with a black matrix 532 at a position overlapping with the partition 504. Furthermore, an overcoat layer 533 is provided so as to cover the color filter 531 and the black matrix 532.

A substrate on the side to which light of the EL element 363 is extracted (in FIG. 6, the substrate 341) may be provided with an optical member for efficient extraction of light from the EL element 363. For example, as the optical member, a hemispherical lens, a micro lens array, a film provided with an uneven surface structure, a light diffusing film, or the like can be used.

This embodiment can be implemented in appropriate combinations with any of the other embodiments.

### Embodiment 2

In this embodiment, as in Embodiment 1, technology related to a display device for reducing eye strain is described.

### <1.1. Blue Light Cut>

Blue light refers to high-energy light (wavelength: 360 nm to 495 nm) in the visible range. Blue light reaches the retina in the eye without being absorbed by the cornea or the lens, and therefore causes damage to the retina or the optic nerve. In addition, exposure to blue light late at night causes disturbance of the circadian rhythm. The danger from blue light lies in the low visibility of light in that wavelength range to human eyes. Even when exposed to intense blue light, humans cannot be aware of it and therefore damage is easily accumulated.

Blue light is short-wavelength light and is thus more likely to be scattered than long-wavelength light (such as green light or red light). In addition, blue light is easily refracted and thus has a short focal length. When a user keeps looking at a screen of a display device for a long time while much blue light is being emitted from the screen, it continues to be difficult to focus the eye even though the user constantly tries to focus the eye like an autofocus camera, which might cause overuse of eye muscles. In this manner, blue light leads to both nervous eye strain and muscular eye strain.

Therefore, eye strain can be reduced by minimizing emission of blue light from a screen of a display portion.

For example, the display unit 120 including a liquid crystal module as in FIG. 5B further includes a backlight unit. A light source in the backlight unit can be a cold cathode fluorescent lamp, a light-emitting diode (LED), or the like. It is preferable to use a light source which does not emit blue light as a backlight.

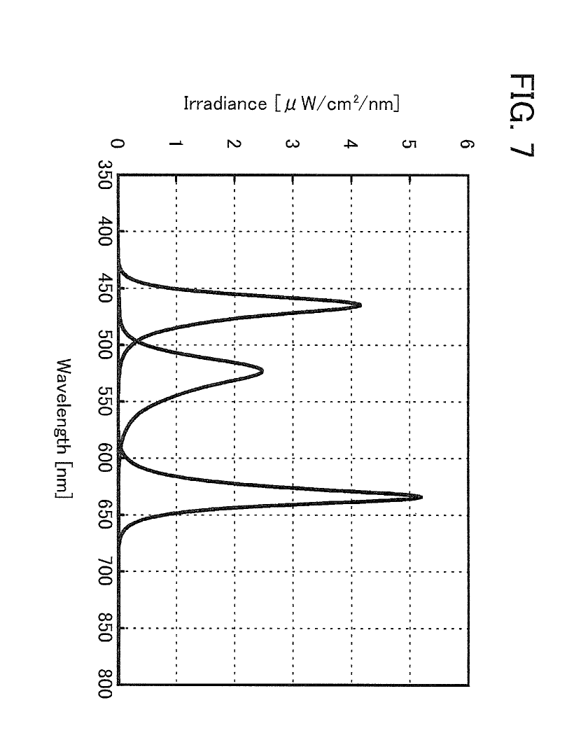

FIG. 7 shows emission spectra of backlights in which measures against blue light are taken. The backlights include LEDs of three colors, red (R), green (G), and blue (B), and white light is obtained from the LEDs of the three colors. As can be seen from FIG. 7, blue LEDs hardly emit light in a wavelength range of 420 nm or less.

### <2.2. Still Image Display>

In a display device, a screen is updated several tens of times per second regardless of whether a display image is a still image or a moving image. The frequency of such screen updating is referred to as refresh rate, and an ordinary display device has a refresh rate of 60 Hz.

Such high-rate screen updating might be perceived by a user as screen flicker. Eye strain is caused by keeping looking at such a screen.

On the other hand, when a natural object or information on paper is looked at, the same object can be looked at all the time. Thus, when a display device displays a still image, it is preferable that the same image can be looked at as long as possible. Therefore, the frequency of screen updating is preferably minimized during still image display, and the refresh rate during still image display is preferably lower than the refresh rate during moving image display. For example, the refresh rate during still image display can be 30 Hz or less and is preferably 1 Hz or less, further preferably 0.2 Hz or less.

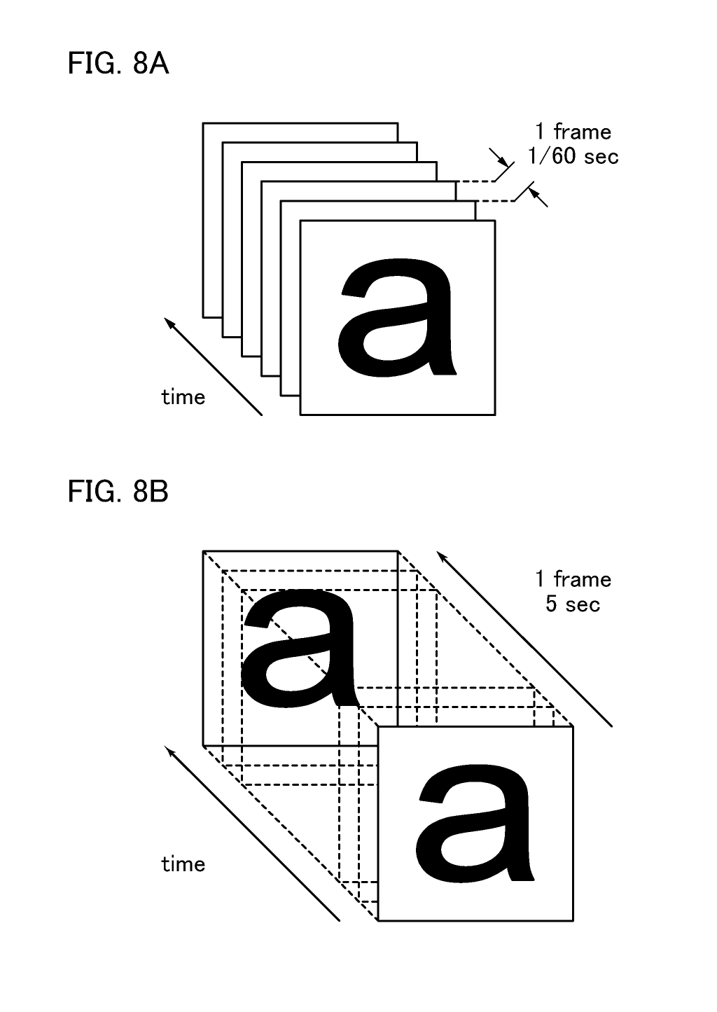

FIG. 8A is a schematic diagram illustrating a conventional method for displaying a still image, and FIG. 8B is a schematic diagram illustrating a method for displaying a still image in this embodiment.

As shown in FIG. 8A, a screen is updated 60 times per second in the conventional display method. The retina, the nerve, or the brain is stimulated by keeping looking at such a screen for a long time and thus eye strain might be caused.

Meanwhile, the length of time the same image is looked at can be increased by decreasing the refresh rate (e.g., updating the screen once every 5 seconds) as illustrated in FIG. 8B, as compared with the display method in FIG. 8A. Thus, flicker on the screen recognized by the user can be reduced. Consequently, stimuli to the retina or the nerve of an eye or the brain of the user are reduced, resulting in less nervous fatigue.

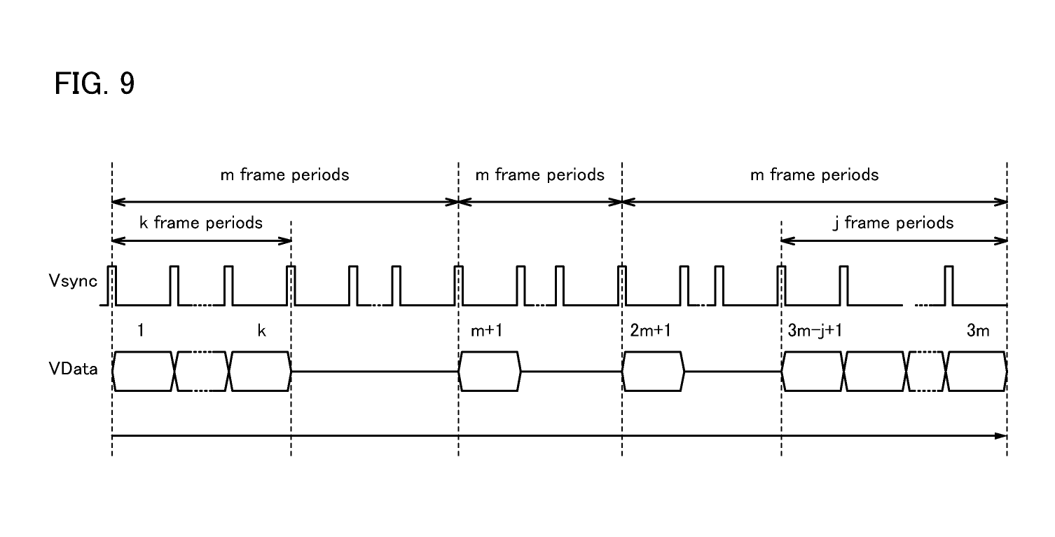

A method for driving the information processing system 100 for displaying a still image as in FIG. 8B is described below with reference to FIG. 9. Here, a method for displaying an image with motion, such as a moving image, and an image without motion, such as a still image, at different refresh rates is described.

For such display, the control circuit 300 of the display unit 120 includes a motion detection portion which detects motion in the image data.

FIG. 9 shows the signal waveforms of the vertical synchronization signal (Vsync) input to the display unit 120 and a data signal (Vdata) output to the data line 313 (see FIG. 4A).

FIG. 9 is a timing chart for the display unit 120 during 3m frame periods. Here, there is motion in image data in the first k frame periods and the last j frame periods and there is no motion in image data in the other frame periods. Note that k and j are each an integer greater than or equal to 1 and less than or equal to m−2.

The motion detection portion of the control circuit 300 performs image processing for detecting motion. In the first k frame periods, the motion detection portion determines that there is motion in image data for each frame. The control circuit 300 outputs data signals (Vdata) to the data line 313 on the basis of the result of determination by the motion detection portion.

When the motion detection portion determines that there is no motion in image data for the (k+1)-th frame, the control circuit 300 stops output of image signals (Video) to the data line driver circuit 322 in the (k+1)-th frame period on the basis of the result of determination. Thus, output of the data signal (Vdata) from the data line driver circuit 322 to the data line 313 is stopped. Further, supply of control signals (e.g., a start pulse signal and a clock signal) to the scan line driver circuit 321 and the data line driver circuit 322 is stopped in order to stop rewriting of the display portion 310. The control circuit 300 does not output an image signal to the data line driver circuit 322 nor supply control signals to the scan line driver circuit 321 and the data line driver circuit 322, thereby keeping rewriting of the pixel portion 310 stopped, until the motion detection portion determines that there is motion in image data.

Note that, in this specification, “to stop supply of a signal” or “not to supply a signal” means to apply voltage which is different from a predetermined voltage for operating a circuit to a wiring for supplying the signal, or to bring the wiring into an electrically floating state.

Note that in the case where a liquid crystal element is used as a display element as in FIG. 4B, when rewriting of the pixel portion 310 is stopped, an electric field in one direction is kept applied to the liquid crystal element, which might lead to deterioration of liquid crystal in the liquid crystal element. In the case where such a problem is likely to occur, it is preferable that signals be supplied to the scan line driver circuit 321 and the data line driver circuit 322 from the control circuit 300 and data signals with an inverted polarity be written into the data line 313 at predetermined timings to invert the direction of the electric field applied to the liquid crystal element, regardless of the result of determination by the control circuit 300.

Here, the polarity of a data signal input to the data line 313 is determined relative to Vcom. The polarity is positive when the voltage of the data signal is higher than Vcom, and is negative when the voltage of the data signal is lower than Vcom.

When the control circuit 300 determines that there is motion in image data for any frame after the (2m+1)-th frame, the control circuit 300 controls the scan line driver circuit 321 and the data line driver circuit 322 to perform rewriting of the pixel portion 310.

As described above, when the driving method in FIG. 9 is employed, the screen can be updated at a lower refresh rate in a still image display mode than in a moving image display mode; thus, the display unit 120 can perform eye-friendly display. In addition, power consumption due to screen updating operations can be reduced by decreasing the refresh rate.

Although the example in which the refresh rate is decreased in the case of image data of a still image is described above, the refresh rate can be decreased by user's setting, control of the control circuit 300, or the like regardless of image data.

### <2.3. Screen Switching>

As described above, strain is placed on eyes by high-rate screen updating without being realized. Thus, eye strain is reduced by performing screen switching in such a manner that the previous image fades out and the next image fades in at the same time so that the screen switching can be performed smoothly and naturally.

An example of a method for switching an image displayed by the display unit 120 from an image A to an image B is described below.

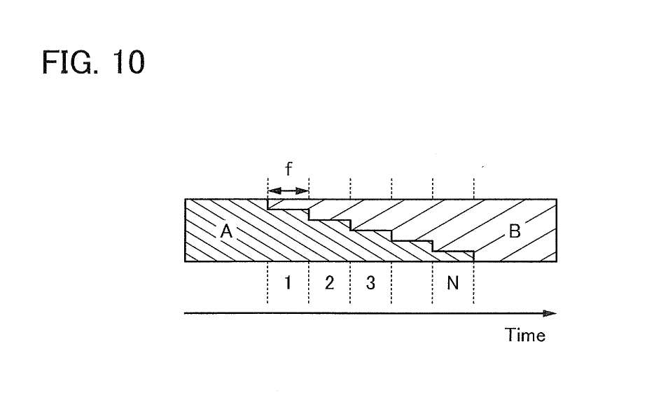

FIG. 10 is a schematic diagram illustrating image data which is generated to gradually switch a display image from the image A to the image B.

As illustrated in FIG. 10, N images (N is a natural number) are displayed between the image A and the image B. Therefore, N sets of image data are generated. An image based on each image data is displayed for f frame periods (f is a natural number). Thus, the period for the switching from the image A to the image B is f×N frame periods. Note that the generation of the image data and the display of the images illustrated in FIG. 10 are performed under the control of the arithmetic portion 110.

It is preferable that the parameters such as N and f can be set by a user. Alternatively, the parameters may be set by an application run by the arithmetic portion 110. These parameters are stored in the memory device 102 of the arithmetic portion 110.

The i-th image data (i is an integer of greater than or equal to 1 and smaller than or equal to N) can be generated by weighting image data of the image A and image data of the image B and summing up the weighted data. For example, in a pixel, when the luminance (gray level) in the case of displaying the image A is a and the luminance (gray level) in the case of displaying the image B is b, the luminance (gray level) c in the case of displaying the i-th image data is a value in Formula 1.

$$\begin{matrix}[ Formula 1 ] & \\ c = \frac{( N - i ) a + ib}{N} & ( 1 )\end{matrix}$$

The image displayed on the screen is switched from the image A to the image B using the image data generated by such a method, so that not continuous images can be switched gradually (smoothly) and naturally.

Note that in Formula 1, in the case where a=0 in all pixels, a black image is gradually switched to the image B (that is, fade-in). Further, in the case where b=0 in all pixels, the image A is gradually switched to a black image (that is, fade-out).

In the example in FIG. 10, two images are switched by overlapping the images temporarily; however, two images are not necessarily overlapped.

In the case where two images are not overlapped with each other, a black image may be inserted while the image A is being switched to the image B. In this case, the above image switching method can be used when the image A is switched to the black image and/or the black image is switched to the image B. The image inserted between the image A and the image B is not limited to a black image, and may be a single color image such as a white image or a multi-color image which is different from the image A and the image B.

When another image, in particular a single color image such as a black image, is inserted between the image A and the image B, a user can feel the switching of images more naturally; thus, images can be switched without giving the user stress.

This embodiment can be implemented in appropriate combinations with any of the other embodiments.

### Embodiment 3

In this embodiment, transistors in the display module 122 (see FIGS. 4B to 4D, FIGS. 5A and 5B, FIG. 6, and the like) of the display unit 120 are described.

As a semiconductor for transistors used in the display module 122, single crystal silicon, polycrystalline silicon, microcrystalline silicon, amorphous silicon, or an oxide semiconductor can be used. Transistors formed using an oxide semiconductor are preferable in terms of display performance of the display module 122.

An oxide semiconductor has a wide energy gap of 3.0 eV or more. A transistor including an oxide semiconductor film obtained by processing the oxide semiconductor under appropriate conditions and by reducing the carrier density sufficiently (hereinafter referred to as “oxide semiconductor transistor”, and other semiconductors are also similar) can have much lower leakage current (off-state current) between a source and a drain in an off state than a conventional silicon transistor.

Accordingly, leakage of charges from a transistor in the pixel 311 can be reduced; therefore, even when the refresh rate is decreased, changes in luminance or transmittance of the pixel 311 in an image data holding period can be reduced.

One example of improvement in display quality of the display unit 120 is an increase in resolution. When the size of each pixel is large (for example, when the pixel density is less than 150 ppi), a character displayed on the display unit 120 is blurred. In the case where the pixel 311 includes a transistor formed using an oxide semiconductor, the size of the pixel can be smaller than in the case where the pixel includes a transistor formed using amorphous silicon or polycrystalline silicon. Thus, the display unit 120 can easily achieve a resolution of 150 ppi. This is because an oxide semiconductor transistor has a higher mobility than an amorphous silicon transistor and therefore can have a smaller size. It is also because although the mobility of the oxide semiconductor transistor is lower than that of a polycrystalline silicon transistor, the off-state current thereof is so low that an element provided in a pixel as a measure against leakage from a transistor becomes unnecessary.

The pixel density of the display unit 120 is 150 ppi or more, preferably 200 ppi or more, more preferably 300 ppi. With a high pixel density, muscular eye strain can be reduced.

An oxide semiconductor suitable for a transistor preferably contains at least indium (In) or zinc (Zn). In particular, In and Zn are preferably contained. The oxide semiconductor may contain one or more kinds of elements which function as stabilizers for reducing variation in electrical characteristics among transistors using the oxide semiconductor. Examples of the elements which function as stabilizers include gallium (Ga), tin (Sn), hafnium (Hf), zirconium (Zr), titanium (Ti), scandium (Sc), yttrium (Y), a lanthanoid (such as cerium (Ce), neodymium (Nd), or gadolinium (Gd)), and the like.

As the oxide semiconductor, for example, an indium oxide, a tin oxide, a zinc oxide, an In—Zn-based oxide, a Sn—Zn-based oxide, an Al—Zn-based oxide, a Zn—Mg-based oxide, a Sn—Mg-based oxide, an In—Mg-based oxide, an In—Ga-based oxide, an In—Ga—Zn-based oxide (also referred to as IGZO), an In—Al—Zn-based oxide, an In—Sn—Zn-based oxide, a Sn—Ga—Zn-based oxide, an Al—Ga—Zn-based oxide, a Sn—Al—Zn-based oxide, an In—Hf—Zn-based oxide, an In—Zr—Zn-based oxide, an In—Ti—Zn-based oxide, an In—Sc—Zn-based oxide, an In—Y—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, or an In—Hf—Al—Zn-based oxide can be used.

Here, an “In—Ga—Zn-based oxide” means an oxide containing In, Ga, and Zn as main components and there is no limitation on the ratio of In:Ga:Zn. The In—Ga—Zn-based oxide may contain a metal element other than In, Ga, and Zn.

Alternatively, a material represented by InMO₃(ZnO)ₘ (m>0) may be used as an oxide semiconductor. Note that M represents one or more metal elements selected from Ga, Fe, Mn, and Co, or the above-described element as a stabilizer. Alternatively, as the oxide semiconductor, a material represented by In₂SnO₅(ZnO)ₙ (n>0) may be used.

For example, an In—Ga—Zn-based oxide with an atomic ratio of In:Ga:Zn=1:1:1, In:Ga:Zn=1:3:2, In:Ga:Zn=3:1:2, or In:Ga:Zn=2:1:3, or an oxide with an atomic ratio close to the above atomic ratios can be used.

When the oxide semiconductor film contains a large amount of hydrogen, hydrogen and the oxide semiconductor are bonded to each other, so that part of hydrogen serves as a donor and causes generation of an electron which is a carrier. As a result, the threshold voltage of the transistor shifts in the negative direction. Therefore, it is preferable that, after formation of the oxide semiconductor film, dehydration treatment (dehydrogenation treatment) be performed to remove hydrogen or moisture from the oxide semiconductor film so that the oxide semiconductor film is highly purified to contain impurities as little as possible.

Note that oxygen in the oxide semiconductor film is also reduced by the dehydration treatment (dehydrogenation treatment) in some cases. Therefore, it is preferable that treatment be performed so that oxygen be added to the oxide semiconductor film to fill oxygen vacancies increased by the dehydration treatment (dehydrogenation treatment). In this specification and the like, supplying oxygen to an oxide semiconductor film may be expressed as oxygen adding treatment, or treatment for making the oxygen content of an oxide semiconductor film be in excess of that of the stoichiometric composition may be expressed as treatment for making an oxygen-excess state.

In the case where an oxide semiconductor film is used for a transistor, the thickness of the oxide semiconductor film is preferably greater than or equal to 2 nm and less than or equal to 40 nm.

In this manner, hydrogen or moisture is removed from the oxide semiconductor film by the dehydration treatment (dehydrogenation treatment) and oxygen vacancies therein are filled by the oxygen adding treatment, whereby the oxide semiconductor film can be turned into an i-type (intrinsic) oxide semiconductor film or a substantially i-type (intrinsic) oxide semiconductor film which is extremely close to an i-type oxide semiconductor film. Note that “substantially intrinsic” means that the oxide semiconductor film contains extremely few (close to zero) carriers derived from a donor and has a carrier density of lower than or equal to 1×10¹⁷/cm³, lower than or equal to 1×10¹⁶/cm³, lower than or equal to 1×10¹⁵/cm³, lower than or equal to 1×10¹⁴/cm³, or lower than or equal to 1×10¹³/cm³.

Thus, the transistor including an i-type or substantially i-type oxide semiconductor film can have extremely favorable off-state current characteristics. For example, the drain current at the time when the transistor including an oxide semiconductor film is in an off-state can be less than or equal to 1×10⁻¹⁸ A, preferably less than or equal to 1×10⁻²¹ A, further preferably less than or equal to 1×10⁻²⁴ A at room temperature (about 25° C.); or less than or equal to 1×10⁻¹⁵ A, preferably less than or equal to 1×10⁻¹⁸ A, further preferably less than or equal to 1×10⁻²¹ A at 85° C. An off state of a transistor refers to a state where gate voltage is sufficiently lower than the threshold voltage in an n-channel transistor. Specifically, the transistor is in an off state when the gate voltage is lower than the threshold voltage by 1 V or more, 2 V or more, or 3 V or more.

An oxide semiconductor film may be a single-crystal oxide semiconductor film or a non-single-crystal oxide semiconductor film. The non-single-crystal oxide semiconductor film includes any of an amorphous oxide semiconductor film, a microcrystalline oxide semiconductor film, a polycrystalline oxide semiconductor film, a c-axis aligned crystalline oxide semiconductor (CAAC-OS) film, and the like. An oxide semiconductor film may be a stacked film including two or more films of an amorphous oxide semiconductor film, a microcrystalline oxide semiconductor film, and a CAAC-OS film, for example. A structure of an oxide semiconductor film is described below.

In the following description of a crystal structure, the term “parallel” indicates that the angle formed between two straight lines is greater than or equal to −10° and less than or equal to 10°, and accordingly also includes the case where the angle is greater than or equal to −5° and less than or equal to 5°. In addition, the term “perpendicular” indicates that the angle formed between two straight lines is greater than or equal to 80° and less than or equal to 100°, and accordingly includes the case where the angle is greater than or equal to 85° and less than or equal to 95°.

The amorphous oxide semiconductor film has disordered atomic arrangement and no crystalline component. A typical example thereof is an oxide semiconductor film in which the whole of the film is amorphous and no crystal part exists even in a microscopic region.

The microcrystalline oxide semiconductor film includes a microcrystal (also referred to as nanocrystal) with a size greater than or equal to 1 nm and less than 10 nm, for example. Thus, the microcrystalline oxide semiconductor film has a higher degree of order than the amorphous oxide semiconductor film. Hence, the density of defect states of the microcrystalline oxide semiconductor film is lower than that of the amorphous oxide semiconductor film.

The CAAC-OS film is one of oxide semiconductor films including a plurality of crystal parts, and most of the crystal parts each fit inside a cube whose one side is less than 100 nm. Thus, there is a case where a crystal part included in the CAAC-OS film fits inside a cube whose one side is less than 10 nm, less than 5 nm, or less than 3 nm The density of defect states of the CAAC-OS film is lower than that of the microcrystalline oxide semiconductor film. The CAAC-OS film is described in detail below.

In a transmission electron microscope (TEM) image of the CAAC-OS film, a boundary between crystal parts, that is, a grain boundary is not clearly observed. Thus, in the CAAC-OS film, a reduction in electron mobility due to the grain boundary is less likely to occur.

According to the TEM image of the CAAC-OS film observed in a direction substantially parallel to a sample surface (cross-sectional TEM image), metal atoms are arranged in a layered manner in the crystal parts. Each metal atom layer has a morphology reflected by a surface where the CAAC-OS film is formed (hereinafter, a surface where the CAAC-OS film is formed is referred to as a formation surface) or a top surface of the CAAC-OS film, and is arranged in parallel to the formation surface or the top surface of the CAAC-OS film.

On the other hand, according to the TEM image of the CAAC-OS film observed in a direction substantially perpendicular to the sample surface (planar TEM image), metal atoms are arranged in a triangular or hexagonal configuration in the crystal parts. However, there is no regularity of arrangement of metal atoms between different crystal parts.

From the results of the cross-sectional TEM image and the planar TEM image, alignment is found in the crystal parts in the CAAC-OS film.

A CAAC-OS film is subjected to structural analysis with an X-ray diffraction (XRD) apparatus. For example, when the CAAC-OS film including an InGaZnO₄ crystal is analyzed by an out-of-plane method, a peak appears frequently when the diffraction angle (2θ) is around 31°. This peak is derived from the (009) plane of the InGaZnO₄ crystal, which indicates that crystals in the CAAC-OS film have c-axis alignment, and that the c-axes are aligned in a direction substantially perpendicular to the formation surface or the top surface of the CAAC-OS film.

On the other hand, when the CAAC-OS film is analyzed by an in-plane method in which an X-ray enters a sample in a direction substantially perpendicular to the c-axis, a peak appears frequently when 2θ is around 56°. This peak is derived from the (110) plane of the InGaZnO₄ crystal. Here, analysis (φ scan) is performed under conditions where the sample is rotated around a normal vector of a sample surface as an axis (φ axis) with 2θ fixed at around 56°. In the case where the sample is a single-crystal oxide semiconductor film of InGaZnO₄, six peaks appear. The six peaks are derived from crystal planes equivalent to the (110) plane. On the other hand, in the case of a CAAC-OS film, a peak is not clearly observed even when φ scan is performed with 2θ fixed at around 56°.

According to the above results, in the CAAC-OS film having c-axis alignment, while the directions of a-axes and b-axes are different between crystal parts, the c-axes are aligned in a direction parallel to a normal vector of a formation surface or a normal vector of a top surface. Thus, each metal atom layer arranged in a layered manner observed in the cross-sectional TEM image corresponds to a plane parallel to the a-b plane of the crystal.

Note that the crystal part is formed concurrently with deposition of the CAAC-OS film or is formed through crystallization treatment such as heat treatment. As described above, the c-axis of the crystal is aligned in a direction parallel to a normal vector of a formation surface or a normal vector of a top surface of the CAAC-OS film. Thus, for example, in the case where a shape of the CAAC-OS film is changed by etching or the like, the c-axis might not be necessarily parallel to a normal vector of a formation surface or a normal vector of a top surface of the CAAC-OS film.

Further, the degree of crystallinity in the CAAC-OS film is not necessarily uniform. For example, in the case where crystal growth leading to the CAAC-OS film occurs from the vicinity of the top surface of the film, the degree of the crystallinity in the vicinity of the top surface is higher than that in the vicinity of the formation surface in some cases. Further, when an impurity is added to the CAAC-OS film, the crystallinity in a region to which the impurity is added is changed, and the degree of crystallinity in the CAAC-OS film varies depending on regions.

Note that when the CAAC-OS film with an InGaZnO₄ crystal is analyzed by an out-of-plane method, a peak of 2θ may also be observed at around 36°, in addition to the peak of 2θ at around 31°. The peak of 2θ at around 36° indicates that a crystal having no c-axis alignment is included in part of the CAAC-OS film. It is preferable that in the CAAC-OS film, a peak of 2θ appear at around 31° and a peak of 2θ do not appear at around 36°.

In a transistor using the CAAC-OS film, change in electrical characteristics due to irradiation with visible light or ultraviolet light is small. Thus, the transistor has high reliability.

For example, a CAAC-OS film can be deposited by a sputtering method using a polycrystalline oxide semiconductor sputtering target. When ions collide with the sputtering target, a crystal region included in the sputtering target may be separated from the target along an a-b plane; in other words, a sputtered particle having a plane parallel to an a-b plane (flat-plate-like sputtered particle or pellet-like sputtered particle) may flake off from the sputtering target. In that case, the flat-plate-like or pellet-like sputtered particle reaches a surface where the CAAC-OS film is formed while maintaining their crystal state, whereby the CAAC-OS film can be formed.

The flat-plate-like sputtered particle has, for example, an equivalent circle diameter of a plane parallel to the a-b plane of greater than or equal to 3 nm and less than or equal to 10 nm, and a thickness (length in the direction perpendicular to the a-b plane) of greater than or equal to 0.7 nm and less than 1 nm. Note that in the flat-plate-like sputtered particle, the plane parallel to the a-b plane may be a regular triangle or a regular hexagon. Here, the term “equivalent circle diameter of a plane” refers to the diameter of a perfect circle having the same area as the plane.

For the deposition of the CAAC-OS film, the following conditions are preferably used.

When the substrate temperature during the deposition is increased, migration of the flat-plate-like sputtered particles which have reached the substrate occurs, so that a flat plane of each sputtered particle is attached to the substrate. At this time, the sputtered particles are positively charged, thereby being attached to the substrate while repelling each other; thus, the sputtered particles are not stacked unevenly, so that a CAAC-OS film with a uniform thickness can be deposited. Specifically, the substrate temperature during the deposition is preferably higher than or equal to 100° C. and lower than or equal to 740° C., more preferably higher than or equal to 200° C. and lower than or equal to 500° C.

By reducing the amount of impurities entering the CAAC-OS film during the deposition, the crystal state can be prevented from being broken by the impurities. For example, the concentration of impurities (e.g., hydrogen, water, carbon dioxide, or nitrogen) which exist in the deposition chamber may be reduced. Furthermore, the concentration of impurities in a deposition gas may be reduced. Specifically, a deposition gas whose dew point is −80° C. or lower, preferably −100° C. or lower is used.

Furthermore, preferably, the proportion of oxygen in the deposition gas is increased and the power is optimized in order to reduce plasma damage at the deposition. The proportion of oxygen in the deposition gas is 30 vol % or higher, preferably 100 vol %.

After the CAAC-OS film is deposited, heat treatment may be performed. The temperature of the heat treatment is higher than or equal to 100° C. and lower than or equal to 740° C., preferably higher than or equal to 200° C. and lower than or equal to 500° C. Further, the heat treatment is performed for 1 minute to 24 hours, preferably 6 minutes to 4 hours. The heat treatment may be performed in an inert atmosphere or an oxidation atmosphere. It is preferable to perform heat treatment in an inert atmosphere and then perform heat treatment in an oxidation atmosphere. The heat treatment in an inert atmosphere can reduce the concentration of impurities in the CAAC-OS film in a short time. At the same time, the heat treatment in an inert atmosphere may generate oxygen vacancies in the CAAC-OS film. In such a case, the heat treatment in an oxidation atmosphere can reduce the oxygen vacancies. The heat treatment can further increase the crystallinity of the CAAC-OS film. Note that the heat treatment may be performed under a reduced pressure, such as 1000 Pa or lower, 100 Pa or lower, 10 Pa or lower, or 1 Pa or lower. The heat treatment under the reduced pressure can reduce the concentration of impurities in the CAAC-OS film in a shorter time.

As an example of the sputtering target, an In—Ga—Zn—O compound target is described below.

The In—Ga—Zn—O compound target, which is polycrystalline, is made by mixing InO_{X} powder, GaO_{Y} powder, and ZnO_{Z} powder in a predetermined molar ratio, applying pressure, and performing heat treatment at a temperature higher than or equal to 1000° C. and lower than or equal to 1500° C. Note that X, Y, and Z are given positive numbers. Here, the predetermined molar ratio of InO_{X} powder to GaO_{Y} powder and ZnO_{Z} powder is, for example, 1:1:1, 1:1:2, 1:3:2, 1:9:6, 2:1:3, 2:2:1, 3:1:1, 3:1:2, 3:1:4, 4:2:3, 8:4:3, or a ratio close to these ratios. The kinds of powder and the molar ratio for mixing powder may be determined as appropriate depending on the desired sputtering target.

Alternatively, the CAAC-OS film may be formed by the following method.

First, a first oxide semiconductor film is formed to a thickness of greater than or equal to 1 nm and less than 10 nm. The first oxide semiconductor film is formed by a sputtering method. Specifically, the substrate temperature is set to higher than or equal to 100° C. and lower than or equal to 500° C., preferably higher than or equal to 150° C. and lower than or equal to 450° C., and the proportion of oxygen in a deposition gas is set to higher than or equal to 30 vol %, preferably 100 vol %.

Next, heat treatment is performed so that the first oxide semiconductor film becomes a first CAAC-OS film with high crystallinity. The temperature of the heat treatment is higher than or equal to 350° C. and lower than or equal to 740° C., preferably higher than or equal to 450° C. and lower than or equal to 650° C. Further, the heat treatment is performed for 1 minute to 24 hours, preferably 6 minutes to 4 hours. The heat treatment may be performed in an inert atmosphere or an oxidation atmosphere. It is preferable to perform heat treatment in an inert atmosphere and then to perform heat treatment in an oxidation atmosphere. The heat treatment in an inert atmosphere can reduce the concentration of impurities in the first oxide semiconductor film in a short time. At the same time, the heat treatment in an inert atmosphere may generate oxygen vacancies in the first oxide semiconductor film. In such a case, the heat treatment in an oxidation atmosphere can reduce the oxygen vacancies. Note that the heat treatment may be performed under a reduced pressure, such as 1000 Pa or lower, 100 Pa or lower, 10 Pa or lower, or 1 Pa or lower. The heat treatment under the reduced pressure can reduce the concentration of impurities in the first oxide semiconductor film in a shorter time.

The first oxide semiconductor film with a thickness of greater than or equal to 1 nm and less than 10 nm can be easily crystallized by heat treatment as compared to the case where the first oxide semiconductor film has a thickness of greater than or equal to 10 nm.

Next, a second oxide semiconductor film having the same composition as the first oxide semiconductor film is formed to a thickness of greater than or equal to 10 nm and less than or equal to 50 nm. The second oxide semiconductor film is formed by a sputtering method. Specifically, the substrate temperature is set to higher than or equal to 100° C. and lower than or equal to 500° C., preferably higher than or equal to 150° C. and lower than or equal to 450° C., and the proportion of oxygen in a deposition gas is set to higher than or equal to 30 vol %, preferably 100 vol %.

Next, heat treatment is performed so that solid phase growth of the second oxide semiconductor film from the first CAAC-OS film occurs, whereby the second oxide semiconductor film is turned into a second CAAC-OS film having high crystallinity. The temperature of the heat treatment is higher than or equal to 350° C. and lower than or equal to 740° C., preferably higher than or equal to 450° C. and lower than or equal to 650° C. Further, the heat treatment is performed for 1 minute to 24 hours, preferably 6 minutes to 4 hours. The heat treatment may be performed in an inert atmosphere or an oxidation atmosphere. It is preferable to perform heat treatment in an inert atmosphere and then to perform heat treatment in an oxidation atmosphere. The heat treatment in an inert atmosphere can reduce the concentration of impurities in the second oxide semiconductor film in a short time. At the same time, the heat treatment in an inert atmosphere may generate oxygen vacancies in the second oxide semiconductor film. In such a case, the heat treatment in an oxidation atmosphere can reduce the oxygen vacancies. Note that the heat treatment may be performed under a reduced pressure, such as 1000 Pa or lower, 100 Pa or lower, 10 Pa or lower, or 1 Pa or lower. The heat treatment under the reduced pressure can reduce the concentration of impurities in the second oxide semiconductor film in a shorter time.

In the above-described manner, a CAAC-OS film having a total thickness of 10 nm or more can be formed.

Further, the oxide semiconductor film may have a structure in which a plurality of oxide semiconductor films is stacked.

For example, a structure may be employed in which, between an oxide semiconductor film (referred to as a first layer for convenience) and a gate insulating film, a second layer which is formed using the constituent elements of the first layer and whose electron affinity is lower than that of the first layer by 0.2 eV or more is provided. In this case, when an electric field is applied from a gate electrode, a channel is formed in the first layer, and a channel is not formed in the second layer. The constituent elements of the first layer are the same as the constituent elements of the second layer, and thus interface scattering hardly occurs at the interface between the first layer and the second layer. Accordingly, when the second layer is provided between the first layer and the gate insulating film, the field-effect mobility of the transistor can be increased.

Further, in the case where a silicon oxide film, a silicon oxynitride film, a silicon nitride oxide film, or a silicon nitride film is used as the gate insulating film, silicon contained in the gate insulating film enters the oxide semiconductor film in some cases. When the oxide semiconductor film contains silicon, reductions in crystallinity and carrier mobility of the oxide semiconductor film occur, for example. Thus, it is preferable to provide the second layer between the first layer and the gate insulating film in order to reduce the concentration of silicon in the first layer where a channel is formed. For the same reason, it is preferable to provide a third layer which is formed using the constituent elements of the first layer and whose electron affinity is lower than that of the first layer by 0.2 eV or more so that the first layer is interposed between the second layer and the third layer.

Note that in this specification, the term “oxynitride” refers to a compound which contains more oxygen than nitrogen; the term “nitride oxide” refers to a compound which contains more nitrogen than oxygen.

Such a structure makes it possible to reduce and further prevent diffusion of impurities such as silicon to a region where a channel is formed, so that a highly reliable transistor can be obtained.

In order to make the oxide semiconductor film a CAAC-OS film, the concentration of silicon contained in the oxide semiconductor film is set to lower than or equal to 2.5×10²¹/cm³, preferably lower than 1.4×10²¹/cm³, more preferably lower than 4×10¹⁹/cm³, still more preferably lower than 2.0×10¹⁸/cm³. This is because the field-effect mobility of the transistor may be reduced when the concentration of silicon contained in the oxide semiconductor film is higher than or equal to 1.4×10²¹/cm³, and the oxide semiconductor film may be made amorphous at the interface between the oxide semiconductor film and a film in contact with the oxide semiconductor film when the concentration of silicon contained in the oxide semiconductor film is higher than or equal to 4.0×10¹⁹/cm³. Further, when the concentration of silicon contained in the oxide semiconductor film is lower than 2.0×10¹⁸/cm³, further improvement in reliability of the transistor and a reduction in density of states (DOS) in the oxide semiconductor film can be expected. Note that the concentration of silicon in the oxide semiconductor film can be measured by secondary ion mass spectrometry (SIMS).

This embodiment can be combined with any of the other embodiments as appropriate.

### Embodiment 4

In this embodiment, structure examples of the oxide semiconductor transistor described in Embodiment 3 are described.

<4.1.a. Structure Example 1 of Transistor>

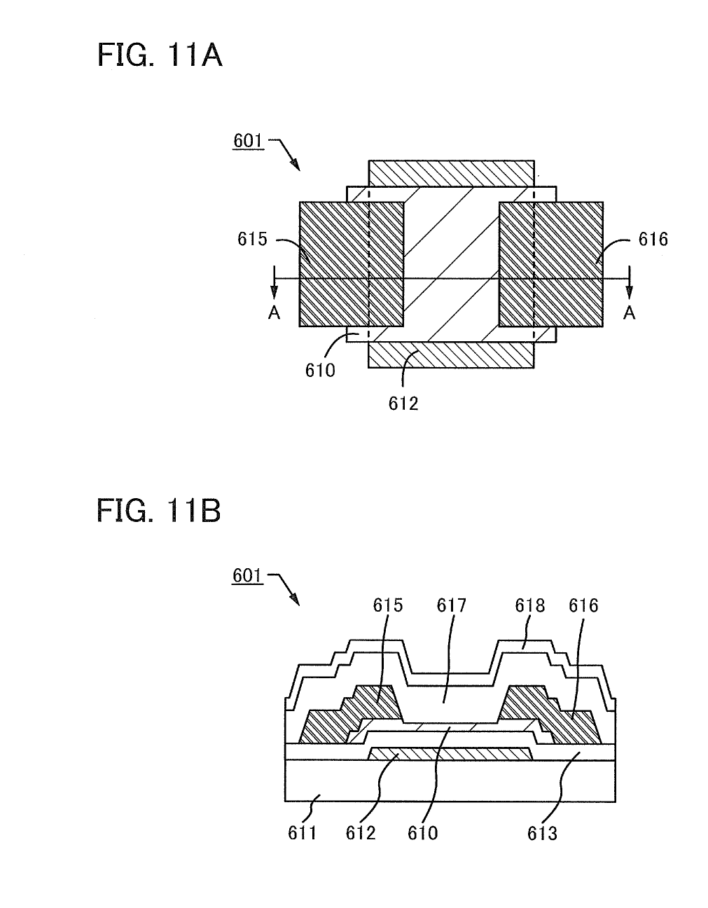

FIG. 11A is a top-view diagram illustrating a structure example of a bottom-gate transistor, and FIG. 11B shows a cross-section taken along the section line A-A in FIG. 11A.

A transistor 601 is formed over a substrate 611. The transistor 601 includes a gate electrode 612, an insulating layer 613, an oxide semiconductor layer 610, and a pair of electrodes 615 and 616 in contact with the top surface of the oxide semiconductor layer 610. The oxide semiconductor layer 610 overlaps with the gate electrode 612 with the insulating layer 613 provided therebetween. The transistor 601 is covered with an insulating layer 617, and an insulating layer 618 is formed over the insulating layer 617.

As the oxide semiconductor layer 610 of the transistor 601, the oxide semiconductor film described in Embodiment 3 can be used.

### <Substrate>

There is no particular limitation on the property of a material and the like of the substrate 611 as long as the material has heat resistance enough to withstand at least heat treatment which will be performed later. For example, a glass substrate, a ceramic substrate, a quartz substrate, a sapphire substrate, or an yttria-stabilized zirconia (YSZ) substrate may be used as the substrate 611. Alternatively, a single crystal semiconductor substrate or a polycrystalline semiconductor substrate made of silicon, silicon carbide, or the like, a compound semiconductor substrate made of silicon germanium or the like, an SOI substrate, or the like can be used as the substrate 611. Still alternatively, any of these substrates provided with a semiconductor element may be used as the substrate 611.

Still alternatively, a flexible substrate such as a plastic substrate may be used as the substrate 611, and the transistor 601 may be provided directly on the flexible substrate. Further alternatively, a separation layer may be provided between the substrate 611 and the transistor 601. The separation layer can be used when part or the whole of the transistor formed over the separation layer is formed and separated from the substrate 611 and transferred to another substrate. Thus, the transistor 601 can be transferred to a substrate having low heat resistance or a flexible substrate.

### <Gate Electrode>

The gate electrode 612 can be formed using a metal selected from aluminum, chromium, copper, tantalum, titanium, molybdenum, and tungsten; an alloy containing any of these metals as a component; an alloy containing any of these metals in combination; or the like. Further, one or more metals selected from manganese and zirconium may be used. Furthermore, the gate electrode 612 may have a single-layer structure or a stacked-layer structure of two or more layers. For example, a single-layer structure of an aluminum film containing silicon, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, and the like can be given. Alternatively, an alloy film containing aluminum and one or more metals selected from titanium, tantalum, tungsten, molybdenum, chromium, neodymium, and scandium; or a nitride film of the alloy film may be used.

The gate electrode 612 can also be formed using a light-transmitting conductive material such as indium tin oxide, indium oxide containing tungsten oxide, indium zinc oxide containing tungsten oxide, indium oxide containing titanium oxide, indium tin oxide containing titanium oxide, indium zinc oxide, or indium tin oxide to which silicon oxide is added. It is also possible to have a stacked-layer structure formed using the above light-transmitting conductive material and the above metal.

Further, an In—Ga—Zn-based oxynitride semiconductor film, an In—Sn-based oxynitride semiconductor film, an In—Ga-based oxynitride semiconductor film, an In—Zn-based oxynitride semiconductor film, a Sn-based oxynitride semiconductor film, an In-based oxynitride semiconductor film, a film of metal nitride (such as InN or ZnN), or the like may be provided between the gate electrode 612 and the insulating layer 613. These films each have a work function higher than or equal to 5 eV, preferably higher than or equal to 5.5 eV, which is higher than the electron affinity of the oxide semiconductor. Thus, the threshold voltage of the transistor including an oxide semiconductor can be shifted in the positive direction, and what is called a normally-off switching element can be achieved. For example, in the case of using an In—Ga—Zn-based oxynitride semiconductor film, an In—Ga—Zn-based oxynitride semiconductor film having a higher nitrogen concentration than that of at least the oxide semiconductor layer 610, specifically, an In—Ga—Zn-based oxynitride semiconductor film having a nitrogen concentration of 7 at. % or higher is used.

### <Insulating Layer>

The insulating layer 613 functions as a gate insulating film. The insulating layer 613 in contact with the bottom surface of the oxide semiconductor layer 610 is preferably an amorphous film.

The insulating layer 613 may be formed to have a single-layer structure or a stacked-layer structure using, for example, one or more of silicon oxide, silicon oxynitride, silicon nitride oxide, silicon nitride, aluminum oxide, hafnium oxide, gallium oxide, Ga—Zn-based metal oxide, silicon nitride, and the like.

The insulating layer 613 may be formed using a high-k material such as hafnium silicate (HfSiOₓ), hafnium silicate to which nitrogen is added (HfSiₓO_{y}N_{z}), hafnium aluminate to which nitrogen is added (HfAlₓO_{y}N_{z}), hafnium oxide, or yttrium oxide, so that gate leakage current of the transistor can be reduced.

### <Electrode>

The electrodes 615 and 616 function as a source electrode and a drain electrode of the transistor 601.

The electrodes 615 and 616 can be formed to have a single-layer structure or a stacked-layer structure using, as a conductive material, any of metals such as aluminum, titanium, chromium, nickel, copper, yttrium, zirconium, molybdenum, silver, tantalum, and tungsten, or an alloy containing any of these metals as its main component. For example, a single-layer structure of an aluminum film containing silicon, a two-layer structure in which a titanium film is stacked over an aluminum film, a two-layer structure in which a titanium film is stacked over a tungsten film, a two-layer structure in which a copper film is stacked over a copper-magnesium-aluminum alloy film, a three-layer structure in which a titanium film or a titanium nitride film, an aluminum film or a copper film, and a titanium film or a titanium nitride film are stacked in this order, a three-layer structure in which a molybdenum film or a molybdenum nitride film, an aluminum film or a copper film, and a molybdenum film or a molybdenum nitride film are stacked in this order, and the like can be given. Note that a transparent conductive material containing indium oxide, tin oxide, or zinc oxide may be used.

### <Insulating Layer>

The insulating layer 617 is preferably formed using an oxide insulating film containing oxygen at a higher proportion than oxygen in the stoichiometric composition. Part of oxygen is released by heating from the oxide insulating film containing oxygen at a higher proportion than oxygen in the stoichiometric composition. The oxide insulating film containing oxygen at a higher proportion than oxygen in the stoichiometric composition is an oxide insulating film in which the amount of released oxygen converted into oxygen atoms is greater than or equal to 1.0×10¹⁸ atoms/cm³, preferably greater than or equal to 3.0×10²⁰ atoms/cm³ in thermal desorption spectroscopy (TDS) analysis.

As the insulating layer 617, a silicon oxide film, a silicon oxynitride film, or the like can be formed. Note that the insulating layer 617 also functions as a film which relieves damage to the oxide semiconductor layer 610 at the time of forming the insulating layer 618 later. Alternatively, an oxide film transmitting oxygen may be provided between the insulating layer 617 and the oxide semiconductor layer 610.

As the oxide film transmitting oxygen, a silicon oxide film, a silicon oxynitride film, or the like can be formed. Note that in this specification, a “silicon oxynitride film” refers to a film that contains oxygen at a higher proportion than nitrogen, and a “silicon nitride oxide film” refers to a film that contains nitrogen at a higher proportion than oxygen.

The insulating layer 618 can be formed using an insulating film having a blocking effect against oxygen, hydrogen, water, and the like. It is possible to prevent outward diffusion of oxygen from the oxide semiconductor layer 610 and entry of hydrogen, water, or the like into the oxide semiconductor layer 610 from the outside by providing the insulating layer 618 over the insulating layer 617. As for the insulating film having a blocking effect against oxygen, hydrogen, water, and the like, a silicon nitride film, a silicon nitride oxide film, an aluminum oxide film, an aluminum oxynitride film, a gallium oxide film, a gallium oxynitride film, an yttrium oxide film, an yttrium oxynitride film, a hafnium oxide film, and a hafnium oxynitride film can be given as examples.

<4.1.b. Example of Method for Manufacturing Transistor>

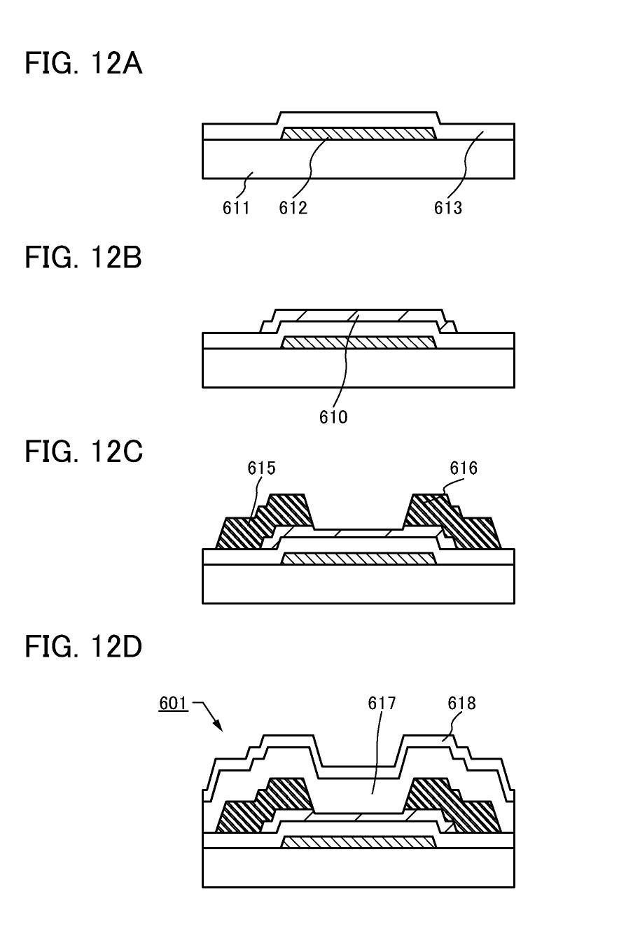

Next, an example of a method for manufacturing the transistor 601 is described with reference to FIGS. 12A to 12D.

First, as illustrated in FIG. 12A, the gate electrode 612 is formed over the substrate 611, and the insulating layer 613 is formed over the gate electrode 612. Here, a glass substrate is used as the substrate 611.

### <Formation of Gate Electrode>

A method for forming the gate electrode 612 is described below. First, a conductive film is formed by a sputtering method, a CVD method, an evaporation method, or the like and then a resist mask is formed over the conductive film using a first photomask by a photolithography process. Next, part of the conductive film is etched using the resist mask to form the gate electrode 612. After that, the resist mask is removed. The gate electrode 612 may be formed by an electrolytic plating method, a printing method, an ink-jet method, or the like.

### <Formation of Gate Insulating Layer>

The insulating layer 613 is formed by a sputtering method, a CVD method, an evaporation method, or the like.

In the case where the insulating layer 613 is formed using a silicon oxide film, a silicon oxynitride film, or a silicon nitride oxide film, a deposition gas containing silicon and an oxidizing gas are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples.

In the case of forming a silicon nitride film as the insulating layer 613, it is preferable to use a two-step formation method. First, a first silicon nitride film with a small number of defects is formed by a plasma CVD method in which a mixed gas of silane, nitrogen, and ammonia is used as a source gas. Next, a second silicon nitride film in which the hydrogen concentration is low and hydrogen can be blocked is formed by switching the source gas to a mixed gas of silane and nitrogen. With such a formation method, a silicon nitride film with a small number of defects and a blocking property against hydrogen can be formed as the insulating layer 613.

Moreover, in the case of forming a gallium oxide film as the insulating layer 613, a metal organic chemical vapor deposition (MOCVD) method or an atomic layer deposition (ALD) method can be employed.

### <Formation of Oxide Semiconductor Layer>

As illustrated in FIG. 12B, the oxide semiconductor layer 610 is formed over the insulating layer 613. A method for forming the oxide semiconductor layer 610 is described below.

First, an oxide semiconductor film is formed using the method described in Embodiment 3. Next, a resist mask is formed over the oxide semiconductor film using a second photomask by a photolithography process. Then, part of the oxide semiconductor film is etched using the resist mask to form the oxide semiconductor layer 610. After that, the resist mask is removed.

After that, heat treatment may be performed. In such a case, the heat treatment is preferably performed under an atmosphere containing oxygen.

Although the oxide semiconductor film which is described in Embodiment 3 can be formed by a sputtering method, such a film may be formed by another method, e.g., a thermal CVD method. A metal organic chemical vapor deposition (MOCVD) method or an atomic layer deposition (ALD) method may be employed as an example of a thermal CVD method.

### <Formation of Electrode>

Next, as illustrated in FIG. 12C, the electrodes 615 and 616 are formed. First, a conductive film is formed by a sputtering method, a CVD method, an evaporation method, or the like. Next, a resist mask is formed over the conductive film using a third photomask by a photolithography process. Then, part of the conductive film is etched using the resist mask to form the electrodes 615 and 616. After that, the resist mask is removed.

Note that as illustrated in FIG. 12C, an upper part of the oxide semiconductor layer 610 is in some cases partly etched and thinned by the etching of the conductive film. For this reason, the oxide semiconductor layer 610 is preferably formed thick.

### <Formation of Insulating Layer>

Next, as illustrated in FIG. 12D, the insulating layer 617 is formed over the oxide semiconductor layer 610 and the electrodes 615 and 616, and the insulating layer 618 is successively formed over the insulating layer 617.

In the case where the insulating layer 617 is formed using a silicon oxide film or a silicon oxynitride film, a deposition gas containing silicon and an oxidizing gas are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples.

The silicon oxide film or the silicon oxynitride film can be formed as follows, for example. The substrate placed in a treatment chamber of a plasma CVD apparatus, which is vacuum-evacuated, is held at a temperature higher than or equal to 180° C. and lower than or equal to 260° C., preferably higher than or equal to 200° C. and lower than or equal to 240° C. The pressure is greater than or equal to 100 Pa and less than or equal to 250 Pa, preferably greater than or equal to 100 Pa and less than or equal to 200 Pa with introduction of a source gas into the treatment chamber. A high-frequency power higher than or equal to 0.17 W/cm² and lower than or equal to 0.5 W/cm², preferably higher than or equal to 0.25 W/cm² and lower than or equal to 0.35 W/cm² is supplied to an electrode provided in the treatment chamber.

As the film formation conditions, the high-frequency power having the above power density is supplied to the treatment chamber having the above pressure, whereby the decomposition efficiency of the source gas in plasma is increased, oxygen radicals are increased, and oxidation of the source gas is promoted; therefore, oxygen is contained in the oxide insulating film at a higher proportion than oxygen in the stoichiometric composition. However, in the case where the substrate temperature is within the above temperature range, the bond between silicon and oxygen is weak, and accordingly, part of oxygen is released by heating. Thus, it is possible to form an oxide insulating film which contains oxygen at a higher proportion than oxygen in the stoichiometric composition and from which part of oxygen is released by heating.

Further, in the case of providing an oxide insulating film between the oxide semiconductor layer 610 and the insulating layer 617, the oxide insulating film serves as a protective film for the oxide semiconductor layer 610 in the steps of forming the insulating layer 617. Thus, the insulating layer 617 can be formed using the high-frequency power having a high power density while damage to the oxide semiconductor layer 610 is reduced.

For example, a silicon oxide film or a silicon oxynitride film is formed as the oxide insulating film under the conditions as follows: the substrate placed in a treatment chamber of a plasma CVD apparatus, which is vacuum-evacuated, is held at a temperature higher than or equal to 180° C. and lower than or equal to 400° C., preferably higher than or equal to 200° C. and lower than or equal to 370° C., the pressure is greater than or equal to 20 Pa and less than or equal to 250 Pa, preferably greater than or equal to 100 Pa and less than or equal to 250 Pa with introduction of a source gas into the treatment chamber, and high-frequency power is supplied to an electrode provided in the treatment chamber. Further, when the pressure in the treatment chamber is greater than or equal to 100 Pa and less than or equal to 250 Pa, damage to the oxide semiconductor layer 610 can be reduced.

A deposition gas containing silicon and an oxidizing gas are preferably used as a source gas of the oxide insulating film. Typical examples of the deposition gas containing silicon include silane, disilane, trisilane, and silane fluoride. As the oxidizing gas, oxygen, ozone, dinitrogen monoxide, and nitrogen dioxide can be given as examples.

The insulating layer 618 can be formed by a sputtering method, a CVD method, or the like.

In the case where the insulating layer 618 is formed using a silicon nitride film or a silicon nitride oxide film, a deposition gas containing silicon, an oxidizing gas, and a gas containing nitrogen are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples. As the gas containing nitrogen, nitrogen and ammonia can be given as examples.

Through the above process, the transistor 601 is manufactured.

### <4.2. Structure Example 2 of Transistor>

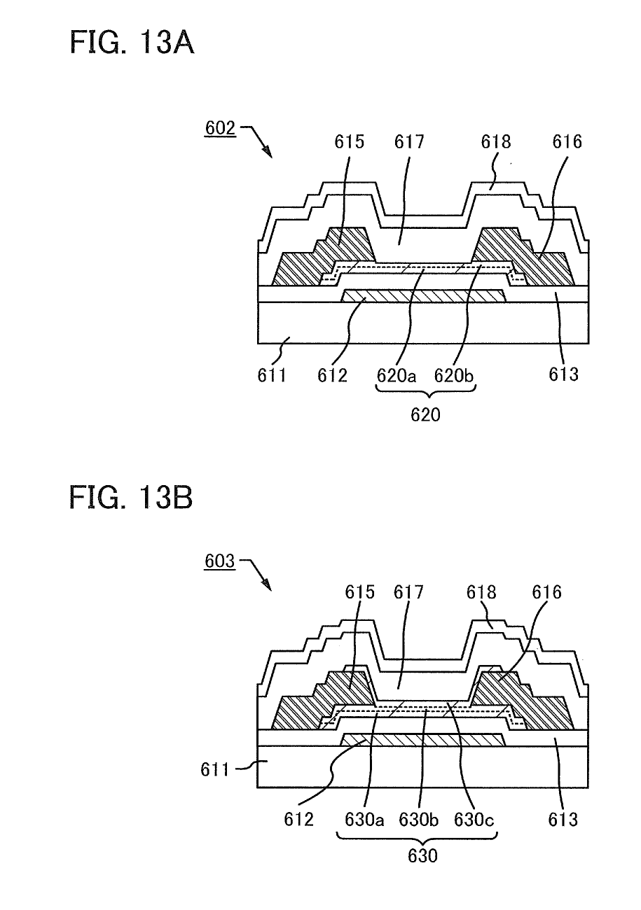

FIG. 13A is a cross-sectional diagram illustrating a structure example of a bottom-gate transistor.

A transistor 602 is different from the transistor 601 in the structure of an oxide semiconductor layer. An oxide semiconductor layer 620 of the transistor 602 has a multi-layer structure and is formed here using a stacked film of an oxide semiconductor layer 620a and an oxide semiconductor layer 620b.

Since a boundary (interface) between the oxide semiconductor layer 620a and the oxide semiconductor layer 620b is unclear in some cases, the boundary is shown by a dashed line in FIG. 13A and the like.

The above-described oxide semiconductor film can be applied to one or both of the oxide semiconductor layers 620a and 620b.

Typical examples of a material that can be used for the oxide semiconductor layer 620a include an In—Ga oxide, an In—Zn oxide, and an In-M-Zn oxide (M is Al, Ti, Ga, Y, Zr, La, Ce, Nd, or Hf). Further, a material having an energy gap of 2 eV or more, preferably 2.5 eV or more, further preferably 3 eV or more is used for the oxide semiconductor layer 620a, for example.

For example, the oxide semiconductor layer 620b contains In or Ga; the oxide semiconductor layer 620b contains, for example, a material typified by an In—Ga oxide, an In—Zn oxide, or an In-M-Zn oxide (M is Al, Ti, Ga, Y, Zr, La, Ce, Nd, or Hf). In addition, the energy level of the conduction band minimum of the oxide semiconductor layer 620b is closer to the vacuum level than that of the oxide semiconductor layer 620a is. The difference between the energy level of the conduction band minimum of the oxide semiconductor layer 620b and the energy level of the conduction band minimum of the oxide semiconductor layer 620a is preferably 0.05 eV or more, 0.07 eV or more, 0.1 eV or more, or 0.15 eV or more and 2 eV or less, 1 eV or less, 0.5 eV or less, or 0.4 eV or less.

Note that in the case where the total atomic percentage of In and M in an In-M-Zn oxide is assumed to be 100 at. %, the atomic ratio between In and M in the semiconductor layer 620a is preferably as follows: the atomic percentage of In is greater than or equal to 25 at. % and the atomic percentage of M is less than 75 at. %; further preferably, the atomic percentage of In is greater than or equal to 34 at. % and the atomic percentage of M is less than 66 at. %. The atomic ratio between In and M in the semiconductor layer 620b is preferably as follows: the atomic percentage of In is less than 50 at. % and the atomic percentage of M is greater than or equal to 50 at. %; further preferably, the atomic percentage of In is less than 25 at. % and the atomic percentage of M is greater than or equal to 75 at. %.

When the oxide semiconductor layer 620a is formed by a sputtering method, an In—Ga—Zn oxide target containing In, Ga, and Zn at an atomic ratio of 1:1:1 or 3:1:2 can be used, for example. Further, when the oxide semiconductor layer 620b is formed by a sputtering method, an In—Ga—Zn oxide target containing In, Ga, and Zn at an atomic ratio of 1:3:2, 1:6:4, or 1:9:6 can be used. Note that the atomic ratios of the oxide semiconductor layers 620a and 620b can be different from those of the targets used in some cases and there could be a difference of ±20% therebetween.

When an oxide containing a large amount of Ga that serves as a stabilizer is used for the oxide semiconductor layer 620b provided over the oxide semiconductor layer 620a, oxygen can be prevented from being released from the oxide semiconductor layers 620a and 620b.

Note that, without limitation to those described above, a material with an appropriate composition may be used depending on required semiconductor characteristics and electrical characteristics (e.g., field-effect mobility and threshold voltage) of a transistor. Further, in order to obtain required semiconductor characteristics of a transistor, it is preferable that the carrier density, the impurity concentration, the defect density, the atomic ratio of a metal element to oxygen, the interatomic distance, the density, and the like of the oxide semiconductor layers 620a and 620b be set to be appropriate.

Although a structure in which two oxide semiconductor layers are stacked is described above as an example of the oxide semiconductor layer 620, a structure in which three or more oxide semiconductor layers are stacked can also be employed.

### <4.3. Structure Example 3 of Transistor>

FIG. 13B is a cross-sectional diagram illustrating a structure example of a bottom-gate transistor.

A transistor 603 is different from the transistor 601 in the oxide semiconductor layer. An oxide semiconductor layer 630 of the transistor 603 has a multi-layer structure, in which an oxide semiconductor layer 630a, an oxide semiconductor layer 630b, and an oxide semiconductor layer 630c are stacked in this order.

The oxide semiconductor layer 630a and the oxide semiconductor layer 630b are stacked over the insulating layer 613. The oxide semiconductor layer 630c is formed in contact with the top surface of the oxide semiconductor layer 630b and the top surfaces and side surfaces of the electrodes 615 and 616.

As at least one of the oxide semiconductor layers 630a, 630b, and 630c, the oxide semiconductor film described in Embodiment 3 can be used.

For example, as the oxide semiconductor layer 630b, a film similar to the oxide semiconductor layer 620a in FIG. 13A can be used. For example, as the oxide semiconductor layers 630a and 630c, films similar to the oxide semiconductor layer 620b can be used.

When an oxide containing a large amount of Ga that serves as a stabilizer is used for the oxide semiconductor layer 630a provided under the oxide semiconductor layer 630b and the oxide semiconductor layer 630c provided over the oxide semiconductor layer 630b, oxygen can be prevented from being released from the oxide semiconductor layers 630a, 630b, and 630c.

In the case where a channel is mainly formed in the oxide semiconductor layer 630b, for example, an oxide containing a large amount of In can be used for the oxide semiconductor layer 630b and the electrodes 615 and 616 are provided in contact with the oxide semiconductor layer 630b; thus, the on-state current of the transistor 603 can be increased.

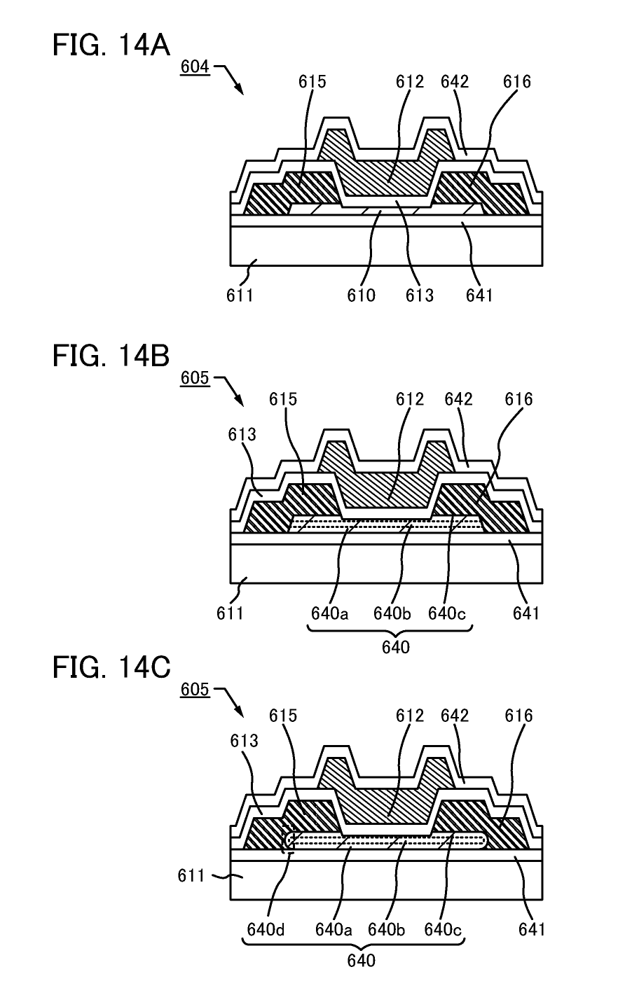

A structure example of a top-gate transistor to which the oxide semiconductor film can be applied is described below with reference to FIGS. 14A to 14C.

### <4.4. Structure Example 4 of Transistor>

FIG. 14A is a cross-sectional view of a top-gate transistor. A transistor 604 is formed over the substrate 611 with an insulating layer 641 provided therebetween. The transistor 604 includes the oxide semiconductor layer 610, the electrodes 615 and 616 in contact with the top surface of the oxide semiconductor layer 610, the insulating layer 613, and the gate electrode 612. An insulating layer 642 is provided so as to cover the transistor 604.

As the oxide semiconductor layer 610 of the transistor 604, the oxide semiconductor film described in Embodiment 3 can be used.

The insulating layer 641 has a function of suppressing diffusion of impurities from the substrate 611 into the oxide semiconductor layer 610. For example, a structure similar to that of the insulating layer 618 can be employed. Note that the insulating layer 641 is not necessarily provided.

The insulating layer 642 can be formed using an insulating film having a blocking effect against oxygen, hydrogen, water, and the like in a manner similar to that of the insulating layer 618. Note that the insulating layer 642 may be formed if necessary.

### <4.5. Structure Example 5 of Transistor>

FIG. 14B is a cross-sectional view of a top-gate transistor.

As illustrated in FIG. 14B, a transistor 605 is different from the transistor 604 in the structure of an oxide semiconductor layer. An oxide semiconductor layer 640 of the transistor 605 includes an oxide semiconductor layer 640a, an oxide semiconductor layer 640b, and an oxide semiconductor layer 640c which are stacked in this order.

As at least one of the oxide semiconductor layers 640a, 640b, and 640c, the oxide semiconductor film described in Embodiment 3 can be used.

For example, as the oxide semiconductor layer 640b, a film similar to the oxide semiconductor layer 620a can be used. For example, as the oxide semiconductor layers 640a and 640c, films similar to the oxide semiconductor layer 620b can be used.

When an oxide containing a large amount of Ga that serves as a stabilizer is used for the oxide semiconductor layer 640a provided under the oxide semiconductor layer 640b and the oxide semiconductor layer 640c provided over the oxide semiconductor layer 640b, oxygen can be prevented from being released from the oxide semiconductor layers 640a, 640b, and 640c.

For example, the oxide semiconductor layer 640c can be formed as follows. The oxide semiconductor layer 640c is formed in the following manner: the oxide semiconductor layer 640c and the oxide semiconductor layer 640b are obtained by etching, so that an oxide semiconductor film to be the oxide semiconductor layer 640a is exposed; and the oxide semiconductor film is processed into the oxide semiconductor layer 640c by a dry etching method. In that case, a reaction product of the oxide semiconductor film is attached to side surfaces of the oxide semiconductor layers 640b and 640c to form a sidewall protective layer (also referred to as a rabbit ear) in some cases. Note that the reaction product is attached by a sputtering phenomenon or through plasma at the time of the dry etching.

FIG. 14C is a cross-sectional view of a transistor 605 in which a sidewall protective layer 640d is formed as a side surface of the oxide semiconductor layer 640 in the above manner.

The sidewall protective layer 640d mainly contains the same material as the oxide semiconductor layer 640a. In some cases, the sidewall protective layer 640d contains the constituent (e.g., silicon) of a layer provided under the oxide semiconductor layer 640a (the insulating layer 641 here).

A structure in which a side surface of the oxide semiconductor layer 640b is covered with the sidewall protective layer 640d so as not to be in contact with the electrodes 615 and 616 as illustrated in FIG. 14C is preferable. With such a structure, unintended leakage current of the transistor in an off state can be reduced particularly when a channel is mainly formed in the oxide semiconductor layer 640b; thus, a transistor having favorable off-state characteristics can be fabricated. Further, when a material containing a large amount of Ga that serves as a stabilizer is used for the sidewall protective layer 640d, oxygen can be effectively prevented from being released from the side surface of the oxide semiconductor layer 640b; thus, a transistor having excellent stability of electrical characteristics can be fabricated.

This embodiment can be implemented in appropriate combinations with any of the other embodiments described in this specification.

### Embodiment 5

The display module described in Embodiment 1 can function as a touch panel when provided with a touch sensor (a contact detector). The touch panel can function as the display unit 120 and the input unit 130 of the information processing system 100 (FIG. 3).

As the touch sensor, touch sensors of various types such as a capacitive type, a resistive type, a surface acoustic wave type, an infrared ray type, and an optical type can be used.

Examples of the capacitive touch sensor are typically of a surface capacitive type, a projected capacitive type, and the like. Further, examples of the projected capacitive type are of a self capacitive type, a mutual capacitive type, and the like, which differ mainly in the driving method. The use of a mutual capacitive type is preferable because multiple points can be sensed simultaneously.

### <5.1. Structure Example 1 of Touch Panel>

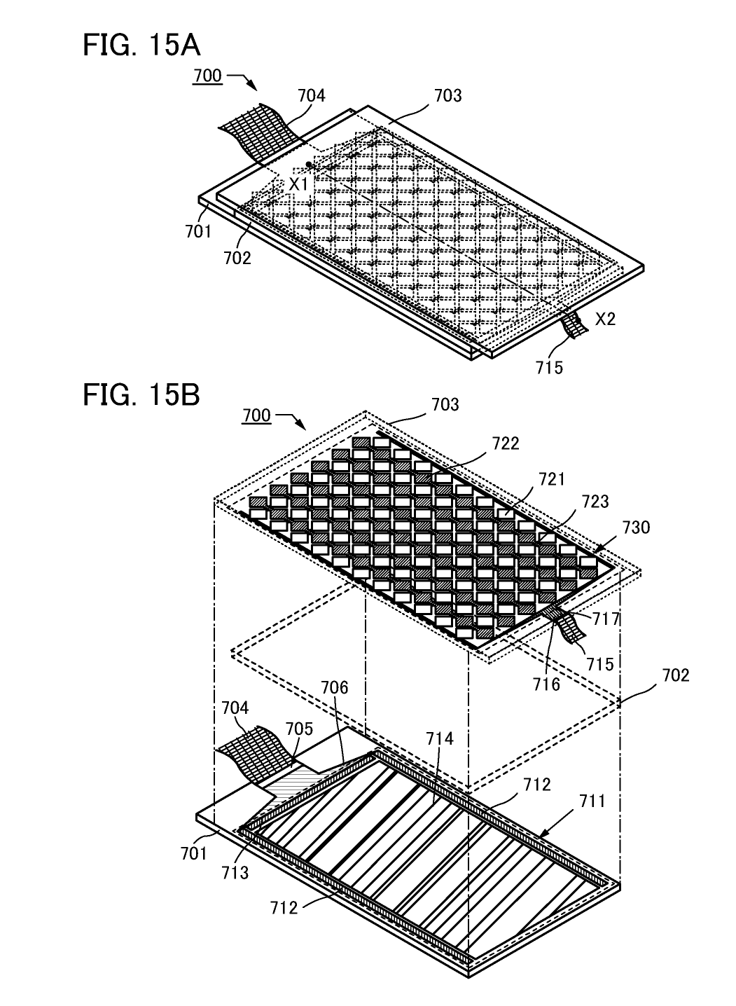

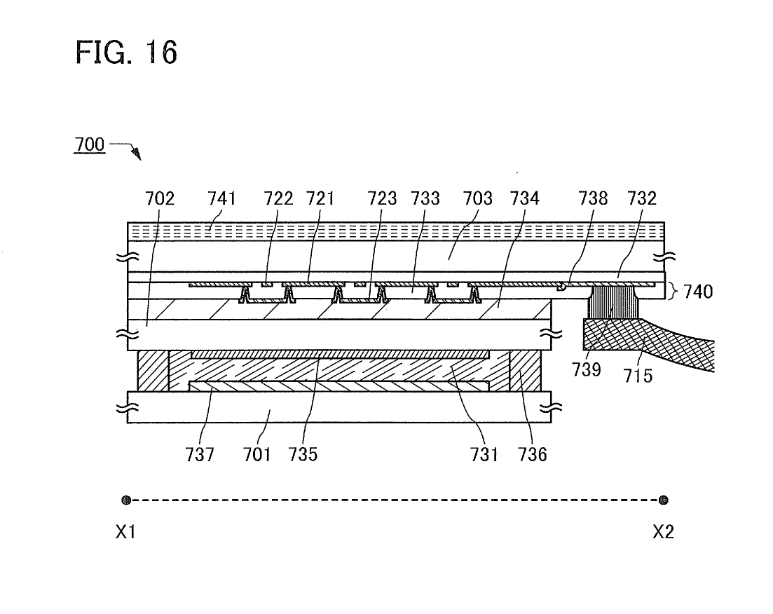

In this embodiment, a display unit provided with a touch sensor (also referred to as a touch panel) is described with reference to FIGS. 15A and 15B and FIG. 16. Description of the same portions as those in the above embodiment is omitted below in some cases.

FIG. 15A is an external perspective diagram illustrating a structure example of a touch panel 700. FIG. 15B is an exploded perspective diagram of FIG. 15A. FIG. 16 is a cross-sectional view taken along the section line X1-X2 in FIG. 15A. Note that FIGS. 15A and 15B illustrate only main components for simplicity.

The touch panel 700 includes a display module 711, a touch sensor 730, and the like.

The display module 711 includes a substrate 701, a substrate 702, an FPC 704, a connection terminal 705 for connection to the FPC 704, and a wiring 706 connected to the connection terminal 705.

The substrate 701 is provided with a pixel portion 714 including a plurality of pixels, a data line driver circuit 712, a scan line driver circuit 713, and the like. The substrate 701 and the substrate 702 are fixed to each other with a sealing member as illustrated in FIG. 4C.

As a display element which can be used in the pixel portion 714 of the display module 711, any of a variety of display elements such as an EL element, a liquid crystal element, and a display element performing display by an electrophoretic method or an electronic liquid powder method can be used. In this embodiment, the case where a liquid crystal element is used as the display element is described.

The touch sensor 730 includes a substrate 703, a plurality of wirings 717, and the like. The substrate 703 is attached to the substrate 702. The plurality of wirings 717 is led to the periphery of the substrate 703, and part of the wirings 717 forms part of a connection terminal 716 for electrical connection to an FPC 715. Note that in FIG. 15B, electrodes, wirings, and the like of the touch sensor 730 which are provided on the back side of the substrate 703 (the back side of the diagram) are indicated by solid lines for clarity.

The touch sensor 730 illustrated in FIG. 15B is an example of a projected capacitive touch sensor. The touch sensor 730 includes electrodes 721, electrodes 722, and the like. The electrodes 721 and the electrodes 722 are each connected to any one of the plurality of wirings 717.

Here, the electrodes 722 are each in the form of a series of quadrangles arranged in one direction as illustrated in FIG. 15B. The electrodes 721 are each in the form of a quadrangle. A plurality of electrodes 721 is arranged in a direction intersecting with the direction in which the quadrangles of each of the electrodes 722 are arranged. The electrodes 721 are connected by wirings 723. The electrodes 722 and the wirings 723 are preferably arranged so that the area of crossing portions becomes as small as possible. With such shapes, regions where the electrodes 721 and 722 are not provided can be reduced, so that a difference in light transmittance between regions of the touch sensor 730 can be reduced.

Note that the shapes of the electrodes 721 and the electrodes 722 are not limited to those in FIG. 15B and can be a variety of shapes. For example, a plurality of electrodes 721 may be arranged so as to have as small a gap as possible, and a plurality of electrodes 722 may be provided thereover with an insulating layer provided therebetween so as to be spaced apart from each other and have regions not overlapping with the electrodes 721. In that case, between two adjacent electrodes 722, it is preferable to provide a dummy electrode which is electrically insulated from these electrodes because the area of regions having different transmittances can be reduced.

As illustrated in FIG. 16, an element layer 737 is provided over the substrate 701. The element layer 737 includes at least a transistor. The element layer 737 may include a capacitor or the like in addition to the transistor. The element layer 737 may includes a driver circuit (a scan line driver circuit and/or a data line driver circuit) or the like. Furthermore, the element layer 737 may include a wiring, an electrode, or the like.

The substrate 702 is provided on one side with a color filter 735 which overlaps with the liquid crystal element. When the color filter 735 includes color filters for three colors, red (R), green (G), and blue (B), a full-color liquid crystal panel can be obtained.

For example, the color filter 735 is formed using a photosensitive material including a pigment by a photolithography process. In the color filter 735, a black matrix may be provided between color filters for different colors. Furthermore, an overcoat may be provided so as to cover the color filters and the black matrix.

Note that one electrode of the liquid crystal element may be formed on the color filter 735 depending on the structure of the liquid crystal element. Note that the electrode serves as part of the liquid crystal element to be formed later. An alignment film may be provided on the electrode.

A liquid crystal layer 731 is enclosed with a sealing member 736 between the substrate 701 and the substrate 702. The sealing member 736 is provided so as to surround the element layer 737 and the color filter 735.

As the sealing member 736, a thermosetting resin or an ultraviolet curable resin can be used; for example, an organic resin such as an acrylic resin, a urethane resin, an epoxy resin, or a resin having a siloxane bond can be used. Alternatively, the sealing member 736 may be formed with glass frit including a low-melting-point glass. Further alternatively, the sealing member 736 may be formed with a combination of the organic resin and the glass frit. For example, the organic resin may be provided in contact with the liquid crystal layer 731 and the glass frit is provided outside the organic resin, in which case water and the like can be prevented from entering the liquid crystal from the outside.

The touch sensor 730 is provided over the substrate 702. In the touch sensor 730, the substrate 703 is provided on one side with a sensor layer 740 with an insulating layer 732 provided therebetween. The sensor layer 740 is attached to the substrate 702 with an adhesive layer 734 provided therebetween. The substrate 703 is also provided on the other side with a polarizing plate 741.

The touch sensor 730 can be provided over the display module 711 in such a manner that the sensor layer 740 is formed over the substrate 703 and is then attached to the substrate 702 with the adhesive layer 734 provided over the sensor layer 740.

For the insulating layer 732, an oxide such as a silicon oxide can be used, for example. The electrodes 721 and 722 having a light-transmitting property are provided in contact with the insulating layer 732. The electrodes 721 and the electrodes 722 are formed in such a manner that a conductive film is formed by a sputtering method over the insulating layer 732 that is formed over the substrate 703 and unnecessary portions are then removed by a photolithography process and an etching process. As a light-transmitting conductive material, a conductive oxide such as indium oxide, indium tin oxide, indium zinc oxide, zinc oxide, or zinc oxide to which gallium is added can be used.

A wiring 738 is electrically connected to the electrode 721 or the electrode 722. Part of the wiring 738 serves as an external connection electrode which is electrically connected to the FPC 715. For the wiring 738, a metal material such as aluminum, gold, platinum, silver, nickel, titanium, tungsten, chromium, molybdenum, iron, cobalt, copper, or palladium or an alloy material containing any of these metal materials can be used.

The electrodes 722 are provided in the form of stripes which extend in one direction. The electrodes 721 are provided such that one electrode 722 is sandwiched between a pair of electrodes 721. The wiring 723 which electrically connects the pair of electrodes 721 is provided so as to intersect with the electrode 722. Here, the one electrode 722 and a plurality of electrodes 721 which are electrically connected by the wirings 723 do not necessarily intersect orthogonally and may form an angle of less than 90°.

An insulating layer 733 is provided so as to cover the electrodes 721 and the electrodes 722. As a material of the insulating layer 733, for example, a resin such as an acrylic resin or an epoxy resin, a resin having a siloxane bond, or an inorganic insulating material such as silicon oxide, silicon oxynitride, or aluminum oxide can be used. Openings reaching the electrodes 721 are formed in the insulating layer 733, where the wirings 723 are provided so as to be electrically connected to the electrodes 721. The wirings 723 are preferably formed using a light-transmitting conductive material similar to that of the electrodes 721 and the electrodes 722, in which case a decrease in the aperture ratio of the touch panel is small. Although a material which is the same as that of the electrodes 721 and the electrodes 722 may be used for the wirings 723, a material is preferably selected with priority given to conductivity over transmittance.

An insulating layer covering the insulating layer 733 and the wirings 723 may be provided. The insulating layer can serve as a protection layer.

An opening reaching the wiring 738 is formed in the insulating layer 733 (and the insulating layer serving as a protection layer). A connection layer 739 provided in the opening electrically connects the FPC 715 and the wiring 738 to each other. For the connection layer 739, a known anisotropic conductive film (ACF), a known anisotropic conductive paste (ACP), or the like can be used.

It is preferable that the adhesive layer 734 with which the sensor layer 740 is attached to the substrate 702 have a light-transmitting property. For example, a thermosetting resin or an ultraviolet curable resin can be used; specifically, a resin such as an acrylic resin, a urethane resin, an epoxy resin, or a resin having a siloxane bond can be used.

As the polarizing plate 741, a known polarizing plate can be used. For the polarizing plate 741, a material capable of producing linearly polarized light from natural light or circularly polarized light is used. For example, a material whose optical anisotropy is obtained by disposing dichroic substances in one direction can be used. Such a polarizing plate can be formed in such a manner that an iodine-based compound or the like is adsorbed to a film such as a polyvinyl alcohol film and the film is stretched in one direction, for example. Note that as the dichroic substance, a dye-based compound or the like as well as an iodine-based compound can be used. A film-like, sheet-like, or plate-like material can be used for the polarizing plate 741.

Note that in this embodiment, an example is described in which a projected capacitive touch sensor is used for the sensor layer 740; however, the sensor layer 740 is not limited to this, and a sensor functioning as a touch sensor which senses proximity or touch of a conductive object to be sensed, such as a finger, from the outside of the polarizing plate can be used. The touch sensor provided in the sensor layer 740 is preferably a capacitive touch sensor. Examples of the capacitive touch sensor are of a surface capacitive type, of a projected capacitive type, and the like. Further, examples of the projected capacitive type are of a self capacitive type, a mutual capacitive type, and the like, which differ mainly in the driving method. The use of a mutual capacitive type is preferable because multiple points can be sensed simultaneously.

### <5.2. Structure Example 2 of Touch Panel>

Note that although the touch panel 700 includes an external sensor portion (the touch sensor 730) as illustrated in FIG. 16, the present invention can be applied to touch panels having other structures. A structure example of an in-cell touch panel in which a pixel portion of a liquid crystal module incorporates a touch sensor is described below.

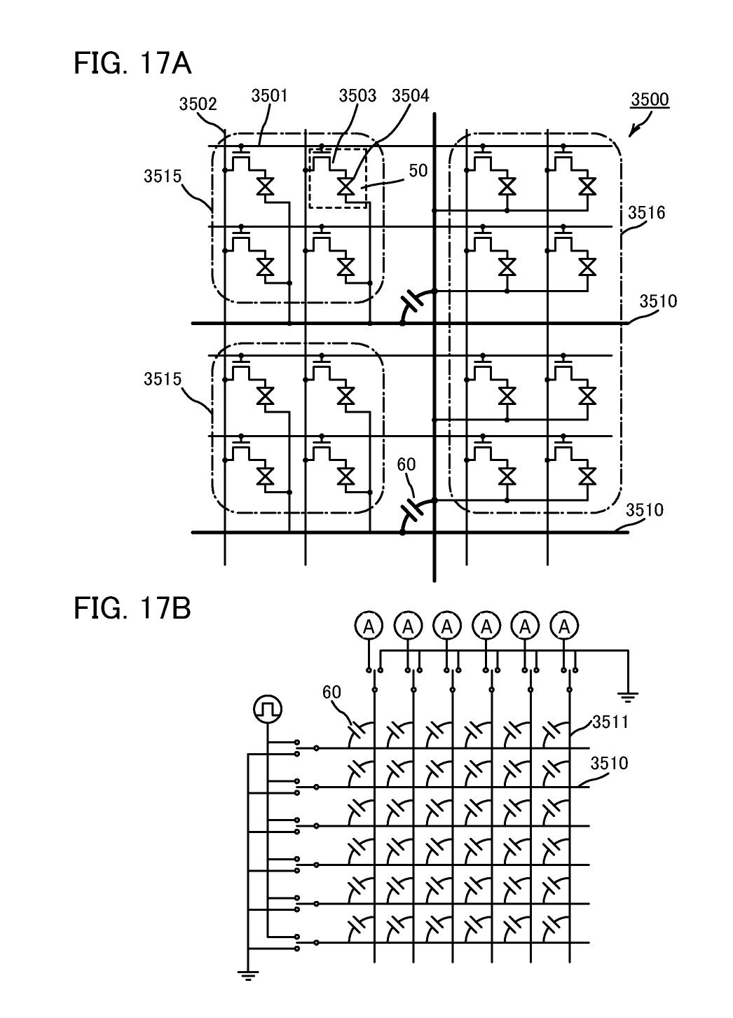

FIG. 17A is a circuit diagram illustrating a structure example of a pixel portion of a touch panel.

A pixel portion 3500 includes a plurality of pixels 50, scan lines 3501, data lines 3502, wirings 3510, and a wiring 3511.

Each of the pixels 50 is connected to the scan line 3501 and the data line 3502 and includes at least a transistor 3503 and a liquid crystal element 3504.

In addition, each of the pixels 50 is connected to the wiring 3510 or the wiring 3511. A plurality of pixels 50 connected to the same wiring 3510 forms one block 3515, and a plurality of pixels 50 connected to the same wiring 3511 forms one block 3516.

The wiring 3510 in the X direction and the wiring 3511 in the Y direction intersect, and a capacitor 60 is formed between the wiring 3510 and the wiring 3511. The approach or contact of an object is sensed by detecting a change in the capacitance of the capacitor 60. FIG. 17B is a circuit diagram with a plurality of wirings 3510 and a plurality of wirings 3511. The circuit in FIG. 17B corresponds to a touch sensor circuit. An input potential or a common potential can be input to each of the wirings 3510. A ground potential can be input to each of the wirings 3511, or a sensing circuit can be electrically connected to each of the wirings 3511.

### [Operation of Touch Panel]

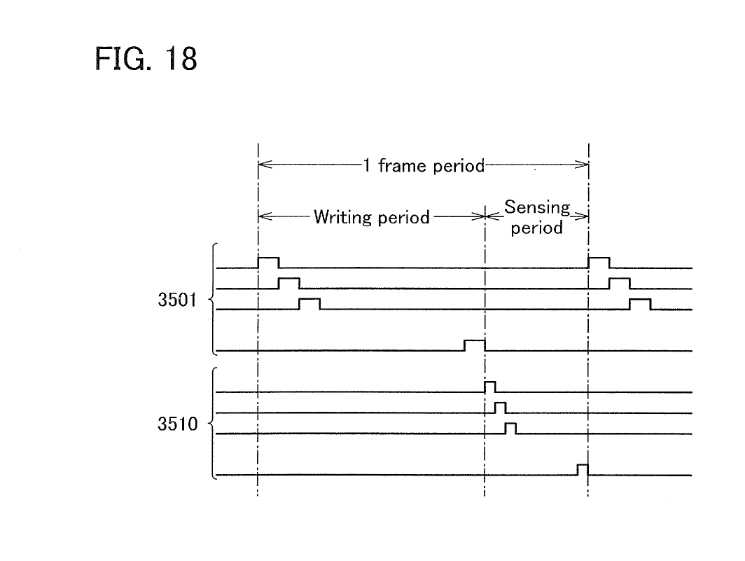

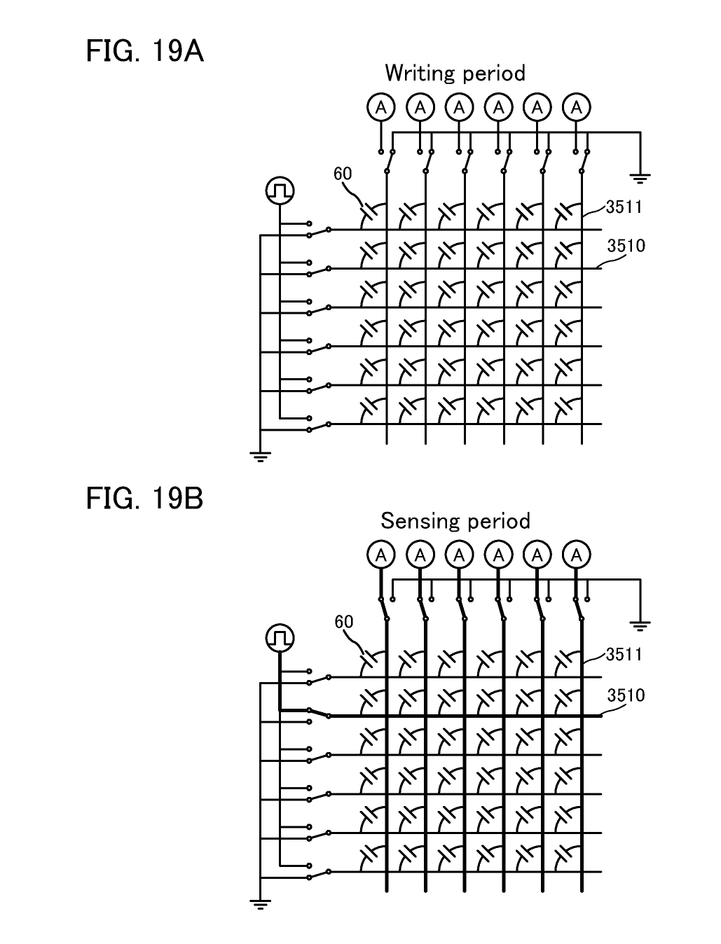

An operation of the touch panel is described with reference to FIG. 18 and FIGS. 19A and 19B.

As illustrated in FIG. 18, one frame period is divided into a writing period and a sensing period. The writing period is a period in which image data is written to a pixel, and the pixels 50 are sequentially selected in accordance with signals input to the wirings 3510 (also referred to as gate lines). The sensing period is a period in which sensing is performed by a touch sensor, and the wirings 3510 extending in the X direction are sequentially selected and input voltage is input.

A circuit in FIG. 19A corresponds to a touch sensor in a writing period. In the writing period, a common potential (a low-level potential) is input to both the wiring 3510 extending in the X direction and the wiring 3511 extending in the Y direction.

A circuit in FIG. 19B corresponds to a touch sensor at a certain point in a sensing period. In the sensing period, each of the wirings 3511 is connected to the sensing circuit. A high-level potential (input potential) is sequentially input to the plurality of wirings 3510.

It is preferable that a period in which image data is written and a period in which sensing is performed by a touch sensor be separately provided as described above. Thus, a decrease in sensitivity of the touch sensor caused by noise generated when data is written to a pixel can be suppressed.

### [Structure Example of Pixel]

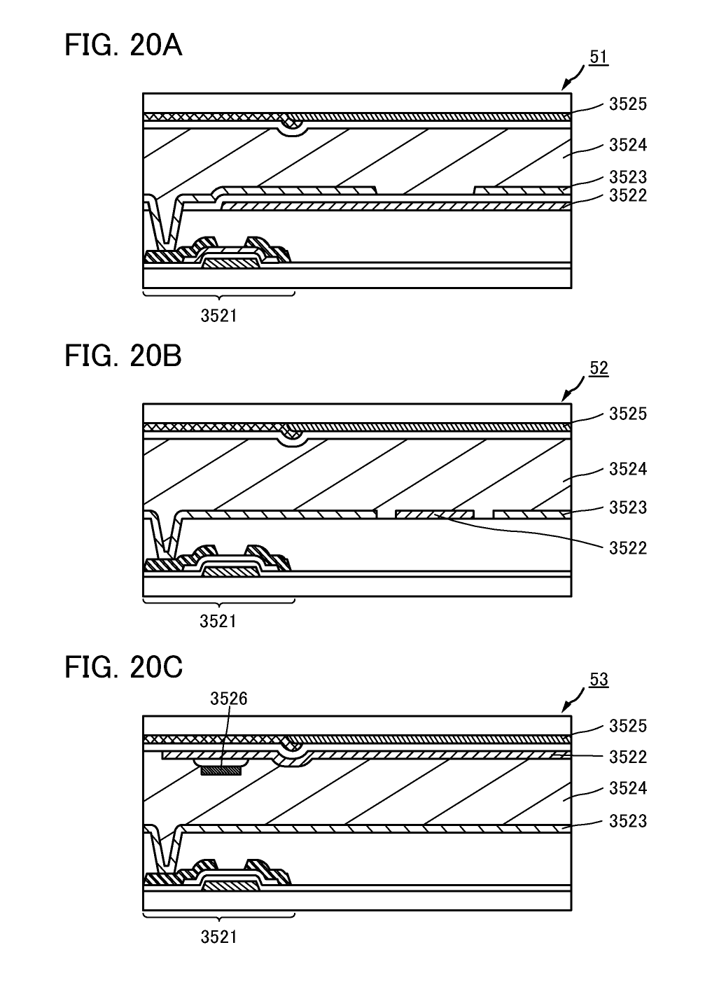

Structure examples of the pixel 50 which can be used in a touch panel are described below with reference to FIGS. 20A to 20C. Note that FIGS. 20A to 20C are cross-sectional diagrams illustrating structure examples of pixels for different display modes, specifically, an FFS mode in FIG. 20A, an in-plane-switching (IPS) mode in FIG. 20B, and a vertical alignment (VA) mode in FIG. 20C.

As illustrated in FIG. 20A, a pixel 51 includes a transistor 3521, an electrode 3522, an electrode 3523, a liquid crystal layer 3524, a color filter 3525, and the like. The electrode 3523 having an opening is electrically connected to one of a source and a drain of the transistor 3521. The electrode 3523 is provided over the electrode 3522 with an insulating layer provided therebetween. The electrode 3523 and the electrode 3522 can each function as one electrode of a liquid crystal element, and by applying different potentials therebetween, alignment of liquid crystals can be controlled.

The electrode 3522 can be provided over the electrode 3523. In that case, the electrode 3522 may have an opening and may be provided over the electrode 3523 with an insulating layer provided therebetween.

For example, when the electrode 3522 is electrically connected to the wiring 3510 or the wiring 3511, a liquid crystal module can operate as a touch panel.

In a pixel 52 for the IPS mode in FIG. 20B, the electrode 3523 and the electrode 3522 have comb-teeth portions engaging with each other and are formed over the same insulating layer. For example, when the electrode 3522 is electrically connected to the above-described wiring 3510 or 3511, a pixel of the above-described touch panel can be obtained.

In a pixel 53 for the VA mode in FIG. 20C, the electrode 3522 and the electrode 3523 are provided on different substrates so as to face each other with the liquid crystal layer 3524 provided therebetween. In addition, a wiring 3526 is provided so as to overlap with the electrode 3522. The wiring 3526 can function as a wiring for electrically connecting a block including the pixel 53 and other blocks. For example, when the electrode 3522 is electrically connected to the above-described wiring 3510 or 3511, a pixel can be obtained.

Note that this embodiment can be combined with any of the other embodiments as appropriate.

### Embodiment 6

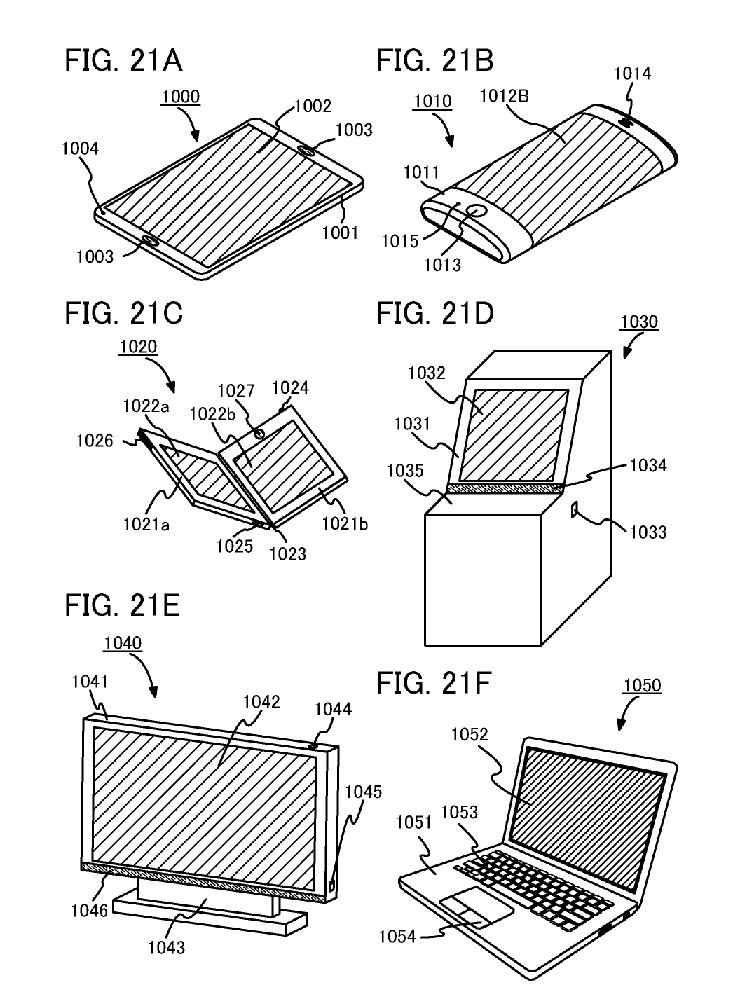

In this embodiment, structure examples of semiconductor devices are described with reference to FIGS. 21A to 21F.

FIG. 21A illustrates a tablet information terminal as an example of an information processing system. An information terminal 1000 includes a touch panel 1002 incorporated in a housing 1001, an operation button 1003, and a speaker 1004. Further, although not shown, the information terminal 1000 includes a microphone, a stereo headphone jack, a memory card insertion slot, a camera, an external connection port such as a USB connector, and the like. The touch panel 1002 is provided with a display module and functions as a display unit and an input unit.

FIG. 21B illustrates a portable information terminal as an example of an information processing system. An information terminal 1010 includes a touch panel 1012B incorporated in a housing 1011, an operation button 1013, a speaker 1014, and a microphone 1015. Further, although not shown, the information terminal 1010 includes a stereo headphone jack, a memory card insertion slot, a camera, an external connection port such as a USB connector, and the like. The touch panel 1012B is provided with a display module and functions as a display unit and an input unit. When a substrate having a curved surface is used as a support substrate of the touch panel 1012B, the information terminal 1010 can be a portable information terminal including a panel with a curved surface.

FIG. 21C illustrates a foldable tablet information terminal as an example of an information processing system. An information terminal 1020 has one or more functions of a telephone, an electronic book, a personal computer, a game machine, and the like.

The information terminal 1020 includes a housing 1021a, a housing 1021b, a touch panel 1022a incorporated in the housing 1021a, a touch panel 1022b incorporated in the housing 1021b, a hinge 1023, an operation button 1024, a connection terminal 1025, a storage medium insertion portion 1026, a speaker 1027, and the like. The touch panel 1022a and the touch panel 1022b are each provided with a display module and function as a display unit and an input unit.

The housing 1021a and the housing 1021b are connected by the hinge 1023. Since the information terminal 1020 includes the hinge 1023, it can be folded so that the touch panels 1022a and 1022b face each other.

The connection terminal 1025 is provided on the housing 1021a. Note that the connection terminal 1025 may be provided on the housing 1021b. Alternatively, a plurality of connection terminals 1025 may be provided on one or both of the housings 1021a and 1021b. The connection terminal 1025 is a terminal for connection to another semiconductor device.

The storage medium insertion portion 1026 is provided on the housing 1021a. The storage medium insertion portion 1026 may be provided on the housing 1021b. Alternatively, a plurality of storage medium insertion portions 1026 may be provided on one or both of the housings 1021a and 1021b. For example, a card storage medium is inserted into the storage medium insertion portion so that data can be read from the card storage medium to the information terminal 1020 or data stored in the information terminal 1020 can be written into the card storage medium.

FIG. 21D illustrates a stationary information terminal as an example of an information processing system. An information terminal 1030 includes a housing 1031, a touch panel 1032 incorporated in the housing 1031, an operation button 1033, a speaker 1034, and the like.

Note that a display unit or an input unit, such as a touch panel similar to the touch panel 1032 or a display module, may be provided on a top board 1035 of the housing 1031. Further, the housing 1031 may be provided with a ticket slot for issuing a ticket or the like, a coin slot, a bill slot, and the like. The information terminal 1030 provided with these devices can serve as an automated teller machine, an information communication terminal (also referred to as multimedia station) for ordering a ticket or the like, or a game machine.

FIG. 21E illustrates an example of a display device. A display device 1040 includes a housing 1041, a display module 1042 incorporated in the housing 1041, a support 1043 for supporting the housing 1041, an operation button 1044, a connection terminal 1045, a speaker 1046, and the like. Instead of the display module 1042, a touch panel may be provided. For example, the display device 1040 can function as a television device or a computer monitor.

The connection terminal 1045 is a terminal for connection to another semiconductor device. For example, an information processing system can be constructed by connecting the display device 1040 and a computer through the connection terminal 1045. Furthermore, a monitor-integrated personal computer can be obtained by incorporating a computer in the housing 1041 of the display device 1040.

FIG. 21F illustrates a notebook type personal computer as an example of an information processing system. A personal computer 1050 includes a housing 1051, a display module 1052, a keyboard 1053, a pointing device 1054, and the like. Instead of the display module 1052, a touch panel can be used.

When the display unit in the semiconductor device described in this embodiment is controlled in a manner described in Embodiment 1 or 2 or the like, the display unit can perform eye-friendly display with less strain on user's eyes.

This embodiment can be implemented in appropriate combinations with any of the other embodiments.

This application is based on Japanese Patent Application serial no. 2012-263310 filed with Japan Patent Office on Nov. 30, 2012, the entire contents of which are hereby incorporated by reference.

What is claimed is:

1. A semiconductor device comprising a display portion, wherein when the display portion displays text, a process of reducing a difference between a gray level of the text and a gray level of a background of the text is performed depending on a scrolling speed of a screen of the display portion.

2. A semiconductor device comprising a display portion, wherein when the display portion displays text, a size of the text is decreased depending on a scrolling speed of a screen of the display portion.

3. The semiconductor device according to claim 1, wherein the display portion comprises a plurality of pixels each including a liquid crystal element.

4. The semiconductor device according to claim 2, wherein the display portion comprises a plurality of pixels each including a liquid crystal element.

5. The semiconductor device according to claim 1, wherein the display portion comprises a plurality of pixels each including an electroluminescent element.

6. The semiconductor device according to claim 2, wherein the display portion comprises a plurality of pixels each including an electroluminescent element.

7. The semiconductor device according to claim 1, wherein the screen of the display portion comprises electronic paper.

8. The semiconductor device according to claim 2, wherein the screen of the display portion comprises electronic paper.

9. The semiconductor device according to claim 1, wherein a refresh rate during still image display by the display portion is lower than a refresh rate during moving image display by the display portion.

10. The semiconductor device according to claim 2, wherein a refresh rate during still image display by the display portion is lower than a refresh rate during moving image display by the display portion.

11. A program for controlling a display portion, comprising the steps of:
determining whether to display text on a screen of the display portion;
determining a scrolling speed of the screen of the display portion; and
reducing a difference between a gray level of the text displayed by the display portion and a gray level of a background of the text depending on the scrolling speed.

12. A program for controlling a display portion, comprising the steps of:
determining whether to display text on a screen of the display portion;
determining a scrolling speed of the screen of the display portion; and
decreasing a size of the text displayed by the display portion depending on the scrolling speed.
